(19) United States
(12) Patent Application Publication
(10) Pub. No.: US 2019/0069497 A1
(43) Pub. Date: Mar. 7, 2019

(54) METHODS AND APPARATUS FOR A HYBRID DISTRIBUTED HYDROCULTURE SYSTEM

(71) Applicant: SproutsIO, Inc., Cambridge, MA (US)

(72) Inventors: Jennifer BROUTIN FARAH, Cambridge, MA (US); Kamal FARAH, Cambridge, MA (US)

(21) Appl. No.: 16/179,536

(22) Filed: Nov. 2, 2018

Related U.S. Application Data
(63) Continuation-in-part of application No. 14/693,179, filed on Apr. 22, 2015, now Pat. No. 10,136,592.
(60) Provisional application No. 62/722,787, filed on Aug. 24, 2018.
(60) Provisional application No. 61/983,212, filed on Apr. 23, 2014.

(51) Int. Cl. A01G 31/02; A01G 9/02; A01G 13/02; A01G 9/00

(52) U.S. Cl. CPC A01G 31/02; A01G 9/006; A01G 13/02; A01G 9/02

(57) ABSTRACT

Described herein are techniques for a hybrid distributed hydroculture system. A set of growing profiles is stored, wherein each growing profile defines a set of growing parameters for a type of plant. Data is received that is indicative of a growing profile being associated with a plant growing unit in communication with the computing device. A set of growing parameters is transmitted from the growing profile to the plant growing unit so that the plant growing unit can execute the growing parameters to grow a plant that is planted in the plant growing unit. Sensor data is received from the plant growing unit indicative of data from one or more sensors locally installed at the plant growing unit. The set of growing parameters is customized based on the sensor data from the plant growing unit to customize the parameters for the plant environment.

### RELATED APPLICATIONS

This patent application is a continuation-in-part of U.S. patent application Ser. No. 14/693,179 filed on Apr. 22, 2015, which claims priority to U.S. Provisional Patent Application No. 61/983,212 filed on Apr. 23, 2014, each of which are hereby incorporated by reference herein in their entirety. This patent application also claims priority to U.S. Provisional Patent Application No. 62/722,787 filed on Aug. 24, 2018, which is hereby incorporated by reference herein in its entirety.

### BACKGROUND

Hydroculture is a method of cultivating plants in a soilless medium through aquatic distribution of water and nutrients. At first, hydroculture was a methodology primarily used for growing plants in lab, allowing scientists to target specific attributes, like nutrients, for testing. With the development of Controlled Environmental Agriculture (CEA) and indoor growing, hydroculture became more frequently used outside of the lab. There are two main types of hydroculture: hydroponic and aeroponic.

Hydroponics delivers nutrients and hydration to plant roots while submerged in water and dissolved nutrients. Support material is used at the base of the plant and sometimes at the roots to hold the plant upright.

Aeroponics employs misters positioned to spray the roots of the plants with nutrient solution, without the use of aggregate medium, such as soil, around the roots. Support material is used at the base of the plant, and the roots are enclosed in the misted chamber, while the canopy of the plant is left open.

### SUMMARY

The techniques described herein can be used to optimize plant growth and resiliency in hydroculture. In some examples, the techniques provide for a distributed system that includes modular growing chambers with dedicated reservoirs and electronics that isolate the root area of each growing chamber, e.g., to contain the spread of disease and mitigate the risk of crop failure in a controlled environment. In some examples, the techniques provide for hybrid hydroculture, including a hybrid hydroculture system that utilizes hydroponics typical during early stage plant growth, hybrid typical during mid stage plant growth, and/or aeroponics typical during mature stage plant growth. In some examples, the techniques provide for networked controls and cloud based communication protocols that enable general system management and independent manipulation of the modular growing chambers in a distributed system. In some examples, the techniques provide for growing profiles for plant and the development of growing algorithm based on plant species and dedicated system attributes. In some examples, the techniques provide for a customizable seed cartridge based on plant type and growth stage.

Disclosed subject matter includes, in one aspect, a computerized method for automatically controlling a set of growing parameters for each of a set of plant growing units, wherein the set of growing parameters for each plant growing unit from the set of plant growing units are customized based on both an environment in which the plant growing unit is located and a type of plant being grown in the plant growing unit. The computerized method includes storing, by a computing device, a set of growing profiles in a database in communication with the computing device, wherein each growing profile defines a set of growing parameters for a type of plant. The computerized method includes receiving, by the computing device, data indicative of a growing profile from the set of growing profiles being associated with a plant growing unit from a set of plant growing units in communication with the computing device. The computerized method includes transmitting, by the computing device, a set of growing parameters from the growing profile to the plant growing unit so that the plant growing unit can execute the growing parameters to grow a plant that is planted in the plant growing unit. The computerized method includes receiving, by the computing device, sensor data from the plant growing unit indicative of data from one or more sensors locally installed at the plant growing unit. The computerized method includes customizing, by the computing device, the set of growing parameters based on the sensor data from the plant growing unit such that the set of growing parameters can be customized for an environment in which the plant growing unit is located.

Disclosed subject matter includes, in another aspect, a computing system for automatically controlling a set of growing parameters for each of a set of plant growing units, wherein the set of growing parameters for each plant growing unit from the set of plant growing units are customized based on both an environment in which the plant growing unit is located and a type of plant being grown in the plant growing unit. The computing system includes a processor configured to run a module stored in memory that is configured to cause the processor to store a set of growing profiles in a database in communication with the computing system, wherein each growing profile defines a set of growing parameters for a type of plant. The module stored in memory is further configured to cause the processor to receive data indicative of a growing profile from the set of growing profiles being associated with a plant growing unit from a set of plant growing units in communication with the computing device. The module stored in memory is further configured to cause the processor to transmit a set of growing parameters from the growing profile to the plant growing unit so that the plant growing unit can execute the growing parameters to grow a plant that is planted in the plant growing unit. The module stored in memory is further configured to cause the processor to receive sensor data from the plant growing unit indicative of data from one or more sensors locally installed at the plant growing unit. The module stored in memory is further configured to cause the processor to customize the set of growing parameters based on the sensor data from the plant growing unit such that the set of growing parameters can be customized for an environment in which the plant growing unit is located.

Disclosed subject matter includes, in another aspect, a non-transitory computer readable medium comprising executable instructions operable to cause an apparatus to store a set of growing profiles in a database, wherein each growing profile defines a set of growing parameters for a type of plant. The executable instructions are operable to cause an apparatus to receive data indicative of a growing profile from the set of growing profiles being associated with a plant growing unit from a set of plant growing units in communication with the computing device. The executable instructions are operable to cause an apparatus to transmit a set of growing parameters from the growing profile to the plant growing unit so that the plant growing unit can execute the growing parameters to grow a plant that is planted in the plant growing unit. The executable instructions are operable to cause an apparatus to receive sensor data from the plant growing unit indicative of data from one or more sensors locally installed at the plant growing unit. The executable instructions are operable to cause an apparatus to customize the set of growing parameters based on the sensor data from the plant growing unit such that the set of growing parameters can be customized for an environment in which the plant growing unit is located.

These and other capabilities of the disclosed subject matter will be more fully understood after a review of the following figures and detailed description. It is to be understood that the phraseology and terminology employed herein are for the purpose of description and should not be regarded as limiting.

### BRIEF DESCRIPTION OF THE FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1 is an exemplary diagram of a hybrid distributed hydroculture system in accordance with some embodiments.

FIG. 2 is an exemplary diagram of a hybrid distributed hydroculture system in different rooms and/or buildings in accordance with some embodiments.

FIG. 3 is an exemplary diagram of a hydroculture unit in accordance with some embodiments.

FIG. 4 is an exemplary diagram of how a unit can be adjusted to achieve hydroponic, hybrid and/or aeroponic applications in accordance with some embodiments.

FIG. 5 is an exemplary diagram of a system protocol in accordance with some embodiments.

FIG. 6 is an exemplary diagram of a growing protocol in accordance with some embodiments.

FIG. 7 is an exemplary diagram of a seed cartridge 700 assembly in accordance with some embodiments.

FIG. 8 shows an exemplary cartridge within a micro-gardening system basin in accordance with some embodiments.

FIG. 9 shows an exemplary cartridge hole configuration in accordance with some embodiments.

FIG. 10 shows an exemplary cartridge hole configuration with seeds in accordance with some embodiments.

FIG. 11 shows an exemplary cartridge hole configuration with seeds in accordance with some embodiments.

FIGS. 12-18 show exemplary implementations of the cartridge in accordance with some embodiments.

FIG. 19 shows an exemplary cartridge in accordance with some embodiments.

FIG. 20 shows an exemplary cartridge with seeds in accordance with some embodiments.

FIG. 21 shows a side view of an exemplary cartridge in accordance with some embodiments.

FIG. 22 shows a side view of an exemplary cartridge growing a plant in accordance with some embodiments.

FIG. 23A shows exemplary components of an exemplary cartridge in accordance with some embodiments.

FIG. 23B shows an assembly process 2316 for a cartridge in accordance with some embodiments of the present disclosure.

FIG. 24 shows an exemplary diagram of the assembly process for an exemplary cartridge in accordance with some embodiments.

FIG. 25 shows an exemplary growing experience using an exemplary cartridge in accordance with some embodiments.

FIG. 26 shows an exemplary process for producing cartridges in accordance with the present disclosure in accordance with some embodiments.

FIG. 27 shows how an exemplary cartridge label may include exemplary data in accordance with some embodiments.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid unnecessary complication of the disclosed subject matter. In addition, it will be understood that the embodiments provided below are exemplary, and that it is contemplated that there are other systems and methods that are within the scope of the disclosed subject matter.

### Distributed System

The distributed system described herein can allow for multiple plant types to be grown within one system, while at the same time limiting the spread of disease, reducing failure and allowing for adaptability of the system in multiple configurations. This is made possible through the networked capability of the system for remote control and monitoring.

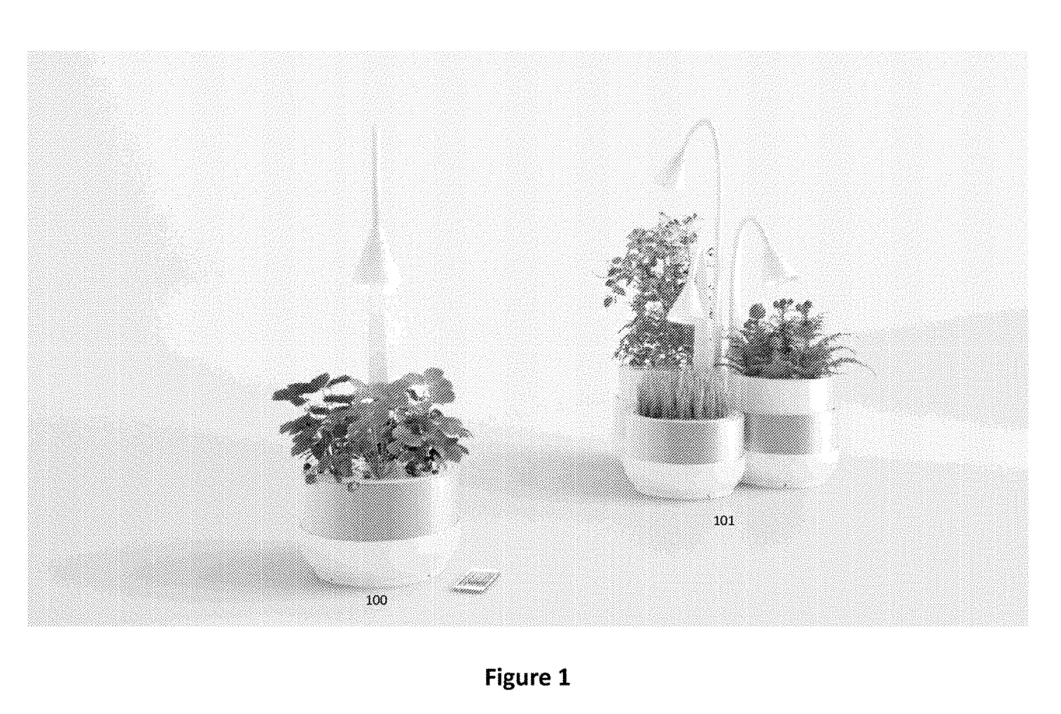

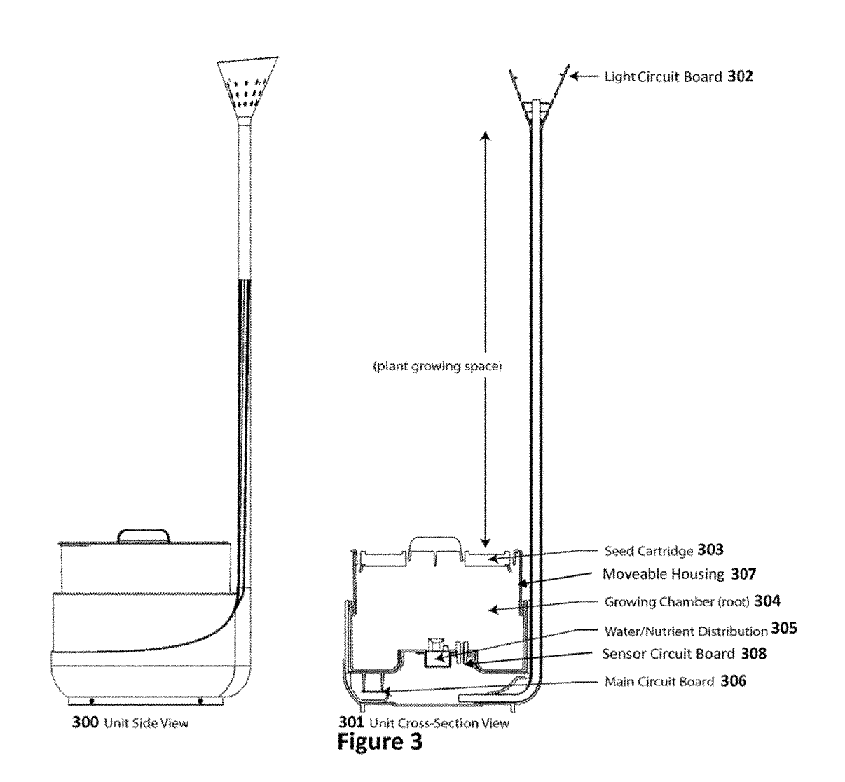

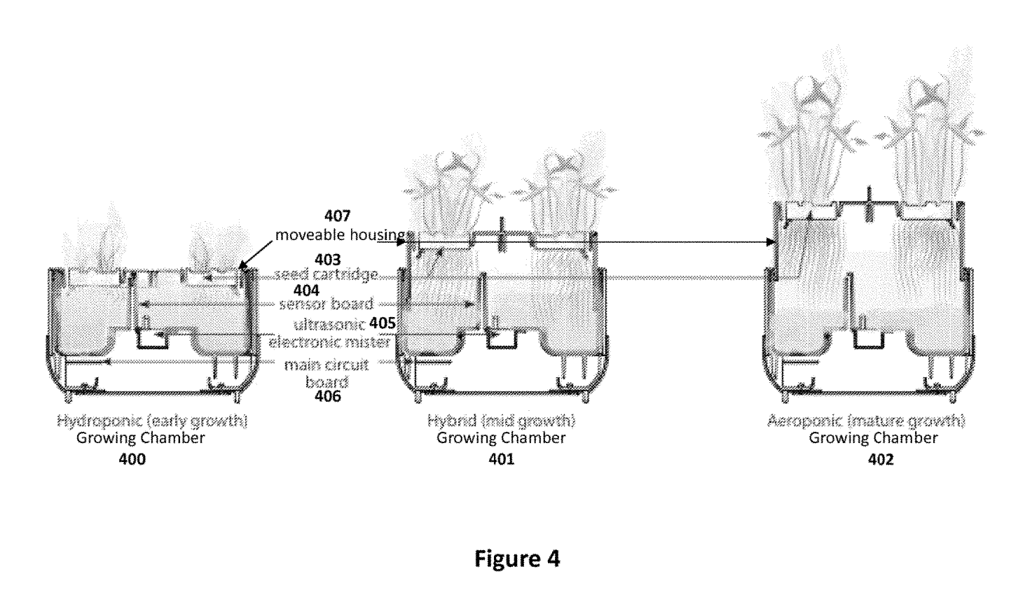

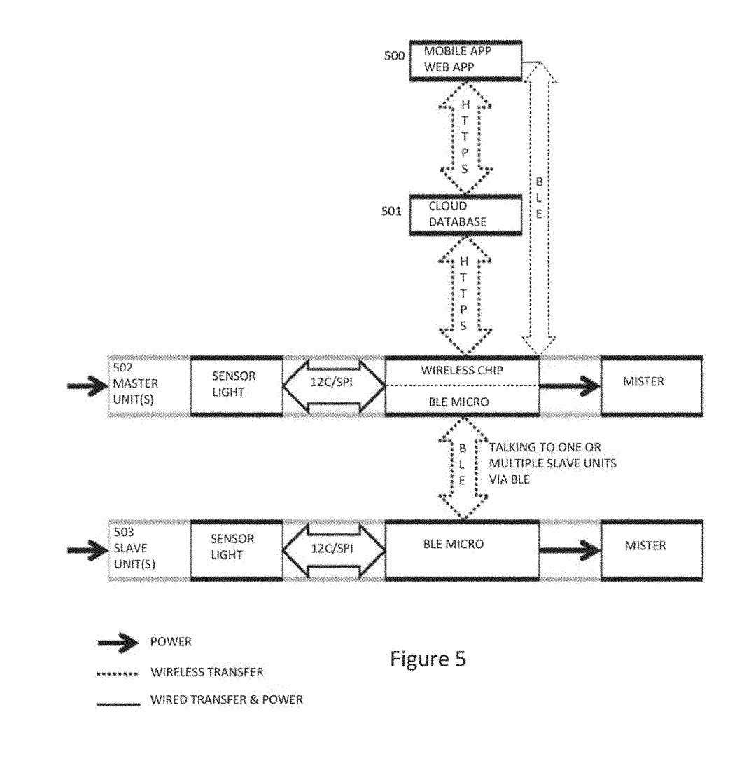

FIG. 1 is an exemplary diagram of a hybrid distributed hydroculture system in accordance with some embodiments. As shown in FIG. 1, each “unit” 100 includes an associated plant type and can be placed alone or with multiple units called a “set” 101 within a room. FIG. 1 shows a single unit and a set with three units. The current embodiment is primarily constructed of plastic, aluminum and urethane. The unit is described in further detail with respect to FIGS. 3 and 4, and the communication among different units or sets is described in further detail with respect to FIG. 5.

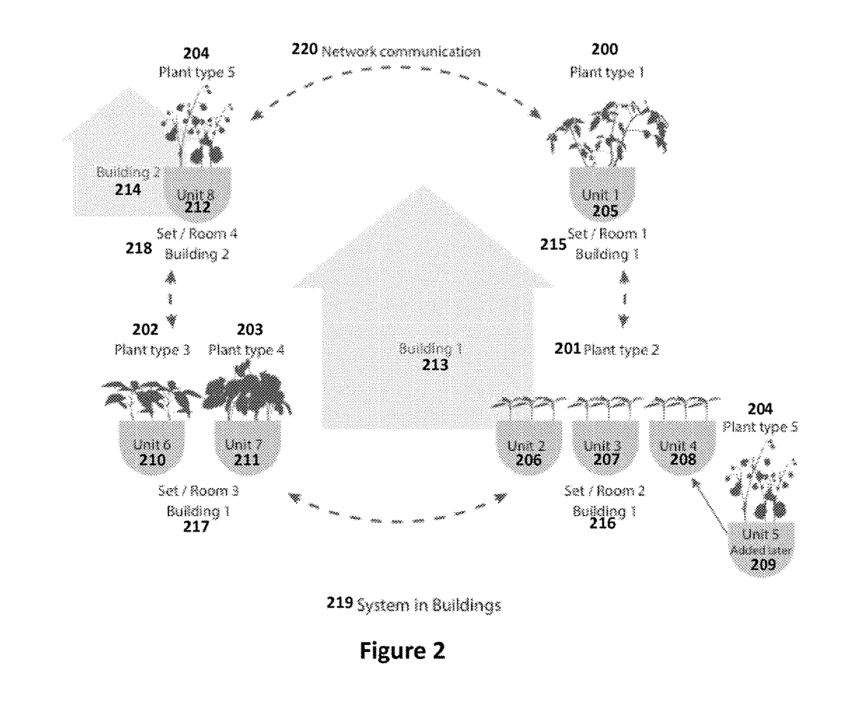

FIG. 2 is an exemplary diagram of a hybrid distributed hydroculture system in different rooms and buildings in accordance with some embodiments. The scenario in FIG. 2 shows eight units and four sets for one “system” within two buildings. The first set/room 215 includes a single unit 205 with a plant type 200. The second set/room 216 includes three units 206-208, all with the same plant type 201, an additional unit 209 is added at a later point with a different plant type 204. The third set/room 217 has two units 210-211, each with a different plant type 202-203. The first three sets/rooms are all in the first building 213. The fourth set/room 218 includes a single unit 212 with a plant type 204 in another building 214. However, one of skill in the art can appreciate that there can be myriad units and sets within multiple buildings as necessary within one system. Each unit can grow one or complementary plant type(s) at a time with multiple plants as the size accommodates. The plant type(s) can then be removed from the unit and a different plant type(s) can be placed. Additionally, units or sets can be added to the system at any point to expand the system, as shown by the addition of unit five 209 with plant type five 204 to the set in room two 216.

Each unit is designed to function in a number of different configurations, including autonomously, within a set, within a system, or any combination thereof. The system is not restricted by space or distance. For example, unit three 207 in building one 213 is part of the same system 219 as unit eight 212 in building two 214, even if they are very far away from one another.

FIG. 3 is an exemplary diagram of a hydroculture unit in accordance with some embodiments. As illustrated in FIG. 3, the unit is comprised of: water/nutrient distribution 305 (electronic mister, pump), growing chamber 304 (dedicated reservoir, expandable housing, sensor circuit board), seed cartridge 303 (with seeds, seed substrate, structure, growing medium, nutrients), light 302 (LED board, heatsink, fan), main circuit board 306 (microcontroller, network capability). In some examples, the main, sensor and light boards may be combined into one or more components. For example, the light/LED circuit board may be incorporated into the main circuit board. These components may be moved or recombined in order to improve their effectiveness. For example, a sensor may achieve better readings if placed in one area rather than another.

The unit includes a water/nutrient distribution 305 component that distributes water and nutrients to the plant. The water/nutrient distribution 305 component can be an electronic mister that includes an ultrasonic diaphragm on the top that produces droplets larger than 5 microns. These droplets create a fog-like water/nutrient vapor that can be absorbed by the plant roots. The vapor is largely contained within the growing chamber 304 and recirculates for water/nutrient conservation. The water/nutrient distribution 305 component can include a pump to aerate and/or circulate the water in the growing chamber 304. The electronic mister and the pump is connected to the main circuit board 306.

The unit includes a growing chamber 304 with a reservoir at the base where water/nutrient solution is stored. The roots of the plant are supported at the top of the growing chamber 304 in the seed cartridge 303 and hang inside of the growing chamber 304 where they are in contact with the water/nutrient solution or vapor from the reservoir.

The growing chamber 304 incorporates a “moveable housing” 307 that allows for the chamber to expand to provide more growing area for plant roots and change from a hydroponic to aeroponic system. The growing chamber 304 also includes a sensor circuit board 308 that monitors the conditions at the root. The sensor circuit board includes humidity, temperature, pH and conductivity sensors presently. The sensor circuit board 308 is connected to the main circuit board 306.

The seed cartridge 303 is an attachment onto the growing chamber 304 and moveable housing 307. The seed cartridge 303 is made of a plastic support with seeds, seed substrate, structure, growing medium, and nutrients specific to plant type. The seed cartridge 303 can be planted, removed and replaced from the system and it is also interchangeable. For example, a strawberry seed cartridge could be placed into unit one and then moved into unit two; a tomato seed cartridge could then be placed into unit one.

The light circuit board 302 includes high efficiency LED's that have different colors and intensity as needed for the plants growing within the unit. The light circuit board 302 currently incorporates a light sensor and camera for recording images of the plants and monitoring lighting conditions. The light circuit board 302 incorporates a microprocessor that is connected to the main circuit board 306.

The main circuit board 306 is the main control and information hub of the unit. It can include power regulation. As described further in FIG. 3, the main circuit board 306 determines whether the unit is a master or a slave. The slave board incorporates a microprocessor that can be Bluetooth (BLE) enabled to communicate with other devices. The slave board also incorporates parts that allow all of the ancillary components (light, sensor, mister) to connect to it. The master board has all of the same components as the slave, in addition to a microprocessor that is Wifi or Ethernet enabled to communicate to the internet and cloud database.

The distributed design of the system can, for example, contain spread, e.g., the distributed growing/reservoir chambers contain the spread of disease at the root, which can be a devastating problem. The distributed growing/reservoir chambers can provide for the ability to space between plant types as needed, which aids in minimizing pests. The distributed design of the system can, for example, provide for co-locating the growing chamber and reservoir, which can conserve water and nutrient use, minimize waste, and/or the like. The system can be configured line-free and nozzle-less, such that clogged or mildew ridden nozzles and water throughways are no longer an issue as they are no longer necessary using an electronic mister. The distributed design of the system can, for example, minimize failure since multi-source misting with electronic ultrasonic misters mitigates failures in the system, unlike standard single source misting with mechanical pumps. For example, if one electronic mister malfunctions, the rest of the units in the system will continue to function because each unit has an associated ultrasonic mister.

### Hybrid Hydroculture

Plants, depending on variety and stage of plant growth, have different needs. Early stage plants often prefer hydroponic cultivation, as they require more moisture and less oxygen at the root. As plants continue to grow, they often prefer aeroponic cultivation more exposure to oxygen and less to moisture at the root. The hybrid hydroculture system herein described can accommodate this change from hydro to a mixed hydro/aero hybrid to aero growing by changing from collapsed to extended growing chambers and varying the amount of solution within the growing chamber.

FIG. 4 is an exemplary diagram of how a units' growing chamber can be adjusted to achieve hydroponic 400, hybrid 401 and/or aeroponic 402 applications in accordance with some embodiments. The unit includes the seed cartridge 403, growing chamber with sensor circuit board 404 and ultrasonic mister 405, and main circuit board 406 as detailed in FIG. 3. The hydroponic configuration 400 is achieved by lowering the area of the seed cartridge 403 so that the roots and cartridge are fully submerged in the solution. The solution level is higher within the growing chamber in the hydroponic state. The aeroponic configuration 402 of the unit is achieved by lifting the seed cartridge area so the roots have more growing room and are exposed to the vapor created from the ultrasonic mister. The solution level is lower within the growing chamber in the aeroponic state. There are varying degrees of hydro/aero (hybrid) state that can occur during the growth process, depending on length of the roots, and how far the moveable growing chamber is extended and the solution level of the growing chamber. The hybrid configuration 401 of the unit is achieved by lifting the seed cartridge area so the roots are partially submerged in water, and partially exposed to the vapor created from the ultrasonic mister. In some embodiments, the user lifts or lowers the moveable housing 407 into place manually. In some embodiments, the moveable housing 407 can be raised and/or lowered automatically.

The hybrid system uses an electronic ultrasonic mister 405 to provide mist particles over 5 microns for sufficient water and nutrient uptake at the root in the aeroponic state. This ultrasonic mister 405 is also in use during the hydroponic state to perturb the water and nutrient mix so that the water does not stagnate (important to keep bacteria and disease from forming at the root) and the nutrients and water are mixed as a solution.

As shown in FIG. 4, the system can be configured to achieve different ways of moving from aeroponic into hydroponic growing environments (e.g., depending how much water is at the base of the system, and/or by moving the seed portion upwards in the system to give more space to the roots of the system). The hybrid design of the system can allow for advances in optimizing soil-free growing. The techniques can provide for optimized plant growth by cycle. For example, the techniques can optimize plant growth at different stages of the plant cycle by utilizing hydroponics, hydro/aero and aeroponics within one system without needing to use separate units. The techniques can optimize plant growth by varietal. For example, varietals can be affected differently by growth in hydroponics, hydro/aero and aeroponics.

### Networked Unit Management Protocol

Networked control and monitoring of a distributed system can be used in order to limit repetitive tasks that would otherwise become inhibitive (such as turning on and off misters on a continual basis). This networked capability can be grouped to control and monitor one or multiple units within the system at one time. For example, units one, two and three are all growing tomatoes and were planted at the same time—the user can control all three units with the same attributes, rather than controlling each individually. Additionally, continuously updated data on system use and plant growth can be recorded for feedback and improvement.

FIG. 5 is an exemplary diagram of the system protocol in accordance with some embodiments. The mobile/web application 500 can function on myriad devices and operating systems including Android, iOS, Windows, OS, Linux. The mobile/web application 500 has functionality to control (lighting and misting on schedule) and also monitor (via the sensor data over time) the units and system.

The system protocol illustrated in FIG. 5 is based on a “master” unit 502 and multiple “slave” units 503. The slave unit 503 can incorporate a sensor circuit board (e.g., temperature, humidity, and/or conductivity), a light circuit board (e.g., LED's, light sensor and camera) a Bluetooth (BLE, Bluetooth low energy) microcontroller, and a mister in its current embodiment. The master unit incorporates the same components with the addition of a wireless or Ethernet enabled chip for network communication to the internet and cloud database.

The master unit serves as an entry and exit gate for information transmitted to the cloud server, which includes a database 501 to store information received from the master unit 502. Each slave unit communicates with a designated master unit 502 to transmit its data to the cloud database 501. Information flows in the opposite direction when commands from a controller such as a mobile/web application 500 are sent to the cloud database 501, then to the master unit 502 and then forwarded on to the appropriate slave unit(s), as necessary. The mobile application/web application 500 can send commands and receive information via Bluetooth (BLE) to a designated master unit directly as well.

It is possible to have multiple master units 502 communicate to the cloud database 501 with or without slave units 503. It is possible to have multiple slave 503 units communicate to a designated master unit 502 that then communicates to the cloud database 501. It is not possible to have slave units 503 communicate to the cloud database 501 without a master unit 502.

The network protocol of the system provides for, for example, automation and data communication between units, sets and systems. The techniques provide an ability to control the system(s) from anywhere, such that the user does not need to be in proximity to the system. The system can provide tiered control, such as by providing the ability to control one unit, a set of units, or on an entire system basis. The techniques provide for data analytics, including setting up a protocol for recording plant growing and system history for analysis.

In some examples, the mobile application/web application 500 can configure a particular growing profile, which is explained in further detail herein, for each unit (e.g., master unit 502 or slave unit 503). The cloud database 501 (e.g., hosted by a cloud server, not shown) stores the growing profiles for each of the units 502 or 503. The growing profile can be used to configure growing settings that are transmitted (e.g., via wireless transmission (e.g., 802.11), Bluetooth, etc.) to each of the units 502 or 503. The units 502 or 503 receive the growing settings and can execute the growing settings (e.g., lighting, misting, fan, and/or the like). The cloud database 501 can also customize the settings based on data indicative of the particular environment of the units 502 or 503 (e.g., temperature, humidity, light and/or the like), as explained further herein.

### Growing Profiles

Growing profiles 605 are analytics associated with a particular plant type based on optimal growing conditions within the system. As explained further herein, growing profiles 605 can be used to configure particular growing settings for a plant type. Additionally, the techniques described herein can be configured to also take into account the individual environment for each growing chamber to customize the growing profiles for the specific environment (e.g., a tomato species growing indoors in a dry/cold climate may have very different configurations than the same tomato species growing outdoors in a warm/humid climate, even though the underlying growing profile configuration for the tomato species is the same).

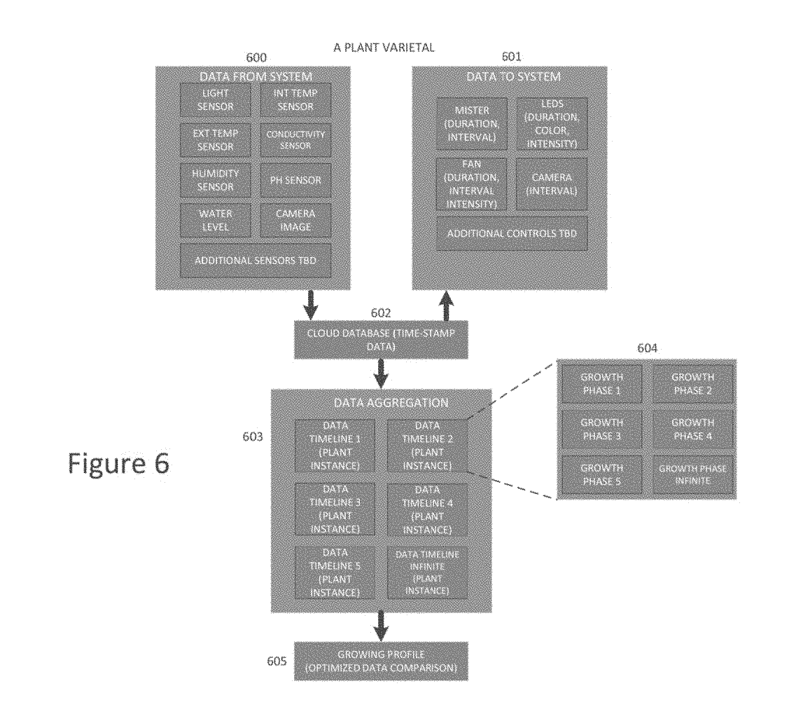

FIG. 6 is an exemplary diagram of a growing profile protocol in accordance with some embodiments. Data from the system 600 indicates data transmitted to the cloud database from one or more units. Data to the system 602 indicates data (e.g., configuration data) transmitted to the one or more units.

In some examples, data from the system 600 can include data from a light sensor, an internal temperature sensor, an external temperature sensor, a pH sensor, a humidity sensor, a conductivity sensor, a camera, and/or any other sensor. The light sensor data can include values for the color and intensity of the light. The internal temperature sensor data can include the internal temperature of the growing chamber at the root area. The external temperature sensor can include the temperature of the plant at the stem/leaves. The pH sensor can include the pH of the solution in the growing chamber at the root area. The humidity sensor can include humidity of the growing chamber at the roots of the plant. The conductivity sensor can include the parts per million (ppm) of nutrients in the solution within the growing chamber in the reservoir area. The camera can include images of the plant from above.

In some examples, data to the system 601 can include misting, camera, fan, light control, and/or any other type of data. Misting can be controlled in terms of duration and interval of mist, and can be set on a calendar schedule. For example: Mist for two minutes every hour on Tuesdays, and mist for 5 minutes every hour on Saturdays. The camera can be controlled in terms of frequency, and can be set on a calendar schedule. The fan can be controlled in terms of duration, interval, intensity and all can be coordinated with a calendar schedule. Lighting can be controlled in terms of color, intensity, and duration, as well as being set on a calendar schedule. For example, the system can be configured to control different spectrums of lighting and lighting intensity (e.g., the system can be configured to provide more bluish light when the plant is younger compared to more reddish light when the plant is more mature). Misting, imaging, fanning and lighting controls can be set for a unit 206, a set 216 or on the whole system 219.

Following is an example of how the growing profile 605 would be implemented. Strawberry plants are planted in a unit. The user can tell the system via the controller (mobile/web application) that this plant has been installed. A preloaded “strawberry” growing profile 605 is associated with the plant that includes sensor data from system 600 (light, temperature, humidity, pH, etc.) and automation schedule pertinent to “strawberry” growing to system 601 for optimal strawberry plant growing. This “strawberry” growing profile 605 establishes a baseline for growing, however it is possible for the profile to be updated and optimized by receiving data/commands from users 500 (via the mobile/web app) and data from environmental conditions and occurrences of plant growing in system to the cloud database/server 602. This has created an instance of the “strawberry” growing profile 603 (e.g. “strawberry 1”), and can be one of many different instances 603 of the “strawberry” growing profile. It is even possible to create instances of a subset of this “strawberry” growing profile for each growth phase (e.g. seedling, mature) 604 to optimize plant growth. For example, a subset of the “strawberry” growing profile can be “strawberry 1, seedling 1”. All of these instances in plant growth 603 and growth phase 604 can be saved and aggregated in the cloud server/database 602 to be utilized toward optimizing the “strawberry” growing profile. The more plants are grown within the system (plant instances 603 and growth phase instances 604), the more intelligent the growing profiles 605 become. In this manner the system will use machine learning to make the growing profiles 605 and become more robust and refined through use.

As another illustrative example of how a growing profile can be modified, assume a type of pepper is being grown in the northeastern US (e.g., Massachusetts) during the summer, and it is located indoors near the window so it is getting natural light. The techniques described herein can be configured to automatically adjust the lighting to give the proper amount of light necessary for the pepper based on light sensor feedback (e.g., since the peppers are receiving some natural light). If the same type of pepper is being grown in South America (e.g., at the same time of year, but it is the winter in the southern hemisphere) and the pepper is getting an entirely different amount/type of light (e.g., since the plant is located in a windowless corner), then the techniques described herein can augment the amount of administered light so that more artificial light is provided than would be provided had the system been located near a window.

As one of skill can appreciate, even though the type of plant may be the same, each growing environment may be different and the system can be configured to accommodate those differences (e.g., using lighting, misting, fans, and/or the like.

The benefits of growing profiles 605 can include control and customization and/or profile optimization. For example, an ideal and customized growing environment for multiple plant types can be maintained simultaneously within one system. As another example, growing profiles can assist users in growing plants according to metrics established for each plant type. As another example, profiles can be constantly updated via updates from users—more users create finer tuned data for profiles, learning over time.

### Seed Cartridge

The seed cartridge 700 serves as the primary means of providing support, structure and nutrients for myriad types of plants at different growth stages.

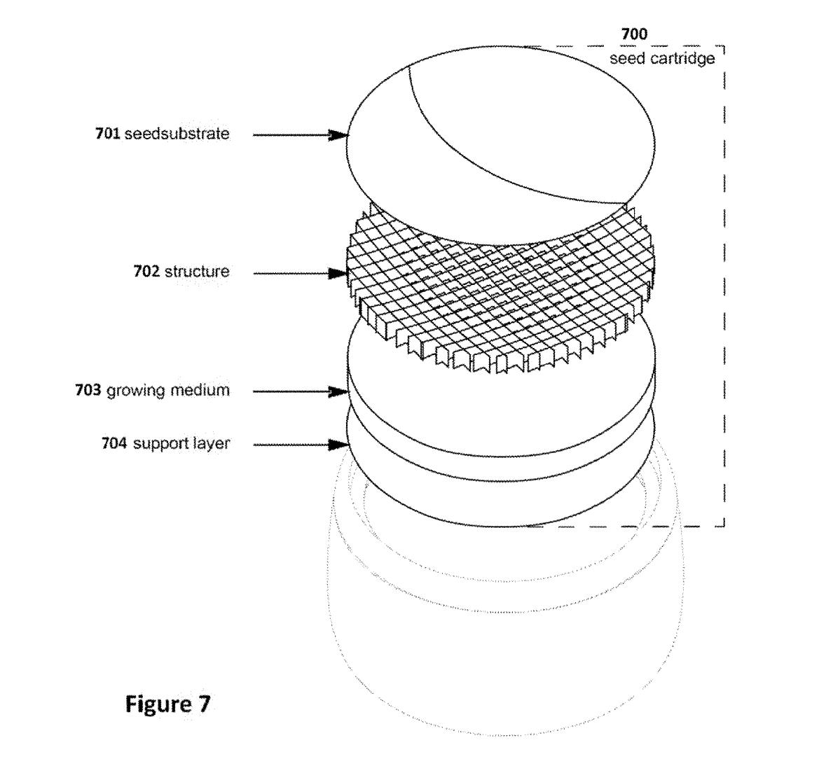

FIG. 7 is an exemplary diagram of a seed cartridge 700 assembly in accordance with some embodiments. The seed substrate 701 provides the layer in which seeds are embedded into the seed cartridge. In some examples this is made of paper and/or any other type of suitable material. The structure 702 provides support for the roots of the plants and can be made to varying thickness and density in order to support large plants with dense, deep root structure (e.g. tomato) to small plants with loose, shallow root structure (e.g. wheatgrass). In some examples this is made of plastic and/or any other type of suitable material. The growing medium 703 provides support, moisture and nutrients at the roots and base of stem through capillary action. In some examples this is made of wool, cotton, felt, peat and/or any other type of suitable material. The support layer 704 can be used to provide additional support to the plants as needed depending on plant type and growth phase. In some examples this is made of wool, cotton, peat and/or any other type of suitable material. These layers can be mixed, matched or multiplied and sandwiched together to make the best seed cartridge for a particular plant type and growth stage, and will be customized as such to optimize plant growth. Nutrients will be added to layers for time release distribution based on plant type and growth phase.

The seed cartridge 700 is transportable and adaptable. It can be added to a unit, removed and then replanted in another unit. It can be added to a unit, removed, and replanted in soil for outdoor growing. In some embodiments, the natural materials, nutrients and layering techniques are designed to last for a given period of time necessary for that particular plant growth and once completed they will disintegrate or can be composted.

The benefits of the seed cartridge 700 can include growth optimization, standardization, and/or interchangeability. For example, the seed cartridge can provide an ideal and customized growing substrate and nutrients for different plant types at different growth stages. As another example, the seed cartridge can provide the ability to maintain optimum growing conditions for different types of plants across multiple seed cartridges 700, reducing the risk of seeds not germinating. As another example, the seed cartridge can be moved from one unit to another throughout growth process, and can be transplanted into soil if desired.

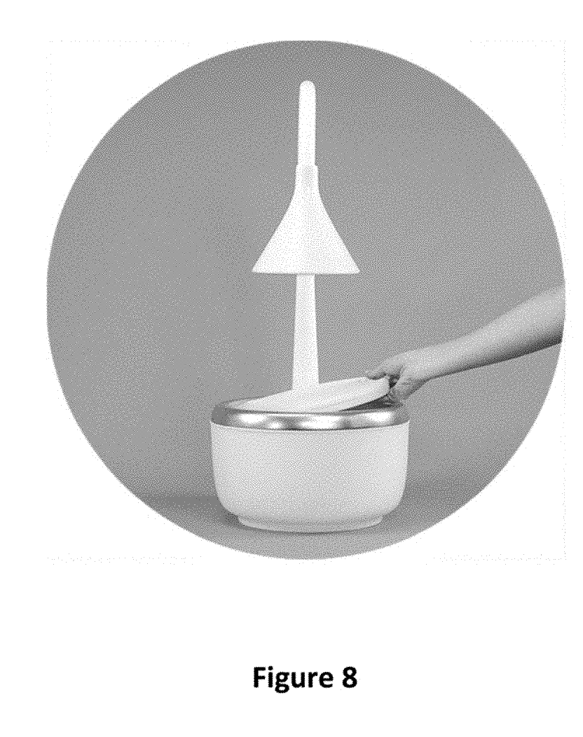

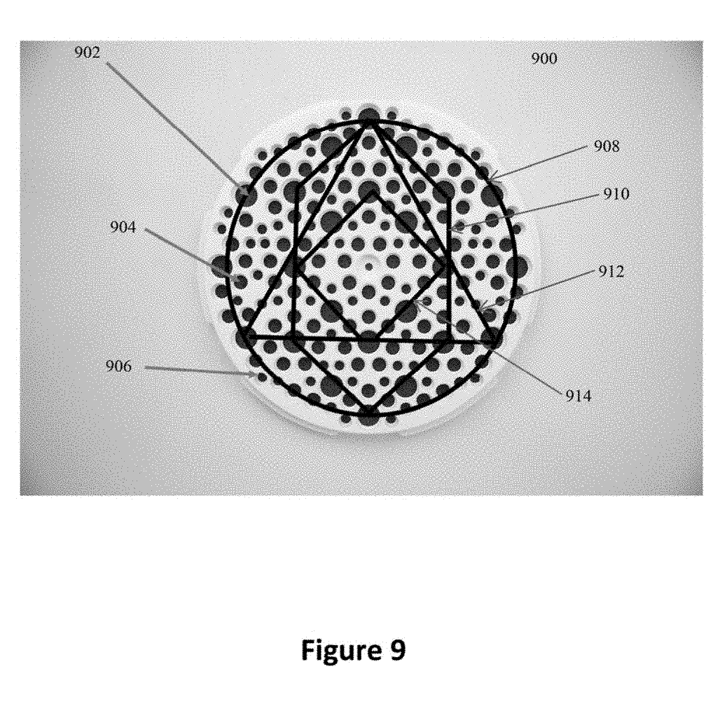

According to embodiments of the present disclosure, a smart, indoor micro-gardening system may allow users to grow plants and vegetables soil free and year-round. The system may, for example, by a unit 100 as previously discussed. As described, the system may include hardware and/or software that allows the system to grow fresh produce, while simultaneously tracking and learning from each plant instance. In some embodiments, this functionality may be made possible by a customizable produce growing cartridge. In one example, the customizable produce growing cartridge may be seed cartridge 700. In some embodiments, upon receipt by a user, the cartridge may be placed into the top of the system basin as shown by FIG. 8. Indeed, FIG. 8 shows an exemplary cartridge within a micro-gardening system basin. Water may be added to the system, and plants may grow through a hole pattern of the cartridge as shown by FIG. 9.

The cartridge may have a multifaceted purpose. For example, the cartridge may be used to contain seeds in their proper locations (based on seed type and/or seeding density, for example), house nutrients, provide enduring support for plants, and/or maintain proper moisture levels. The cartridge may promote growth optimization of a myriad of plants, while allowing for standardization or customization of each plant variety, and can be composted after the plant has been harvested. In some embodiments, the assembly process for a cartridge may be automated at each step and integrated with an ordering system. For example, each cartridge may include a unique identifier, such as a code, that allows for traceability of materials during assembly and fulfillment, and customization of growth settings both before and after growth initiation, so that produce can be grown according to user preferences. In some embodiments, all or some of this information may be tracked in a database. The information may be used to improve and inform future plant instances through system automated feedback, voluntary user input, and/or artificial intelligence, for example. In some embodiments, the database may be a cloud database. For example, the database may be connected to the Internet and/or other databases and/or micro-gardening systems via a wired or wireless connection (e.g., a local areas network, wide area network, cellular network).

FIG. 9 shows an exemplary cartridge 900 having an exemplary hole configuration. For example, cartridge 900 may include a first hole 902, a second hole 904, and an additional hole 906.

Cartridge 900 may have the hole configuration organized such that a number of shapes are formed by the configuration. The holes may be located in one or both of a top and bottom cover of cartridge 900. For example, the hole configuration of cartridge 900 may form one or more of the following: a circular shape 908, hexagonal shape 910, triangular shape 912, and/or square shape 914. Moreover, as shown in FIG. 9, the hole configuration may be a pentagonal shape if the lowest side of triangle 912 intersects hexagon 910. For example, the hole configuration may be any shape formed by connecting holes of cartridge 900. The hole configuration may allow for the growth of a wide range of species within one formfactor (e.g., one cartridge). For example, the holes that form triangular shape 912 may be used for planting large fruiting species (e.g., tomato, pepper, etc.) in three locations on the cartridge, giving the plants room to spread out. For example, first hole 902 may form each of the points of triangular shape 912 and may be used for planting large fruiting species. In another example, the square shape 914 may be used for planting leafy greens, which still may need space to spread, but can be planted closer to one another than the large fruiting varieties. First hole 902 may form each of the corner of square shape 914. One or more of second hole 904 and additional hole 906 may be smaller, non-delineated holes. For example, one or more of second hole 904 and additional hole 906 may be used for smaller plant species, such as microgreens and herbs, that may be spread across the whole cartridge. One or more of the first hole 902, second hole 904, and/or additional hole 906 may form one or more of corners of shapes and/or locations along a contour of a shape, for example. For example, when a hole is located on a contour of the shape, all or part of the hole may be located on a path formed by the shape. For example, a first hole 902 may form a first corner of a shape, and another hole having the same or substantially the same size as first hole 902 (i.e., another first hole 902) may form the second corner of the shape.

Indeed, one or more first holes 902 of the cartridge 900 may be used for fruiting species (e.g., pepper, tomato, beans, etc.), for example. The first holes 902 may be spread out across the cartridge to give these larger species enough room to fully develop and spread out, for example.

One or more second holes 904 of the cartridge, which may be smaller than the first holes, may be closer to one another compared to the first holes, and may be where smaller species (e.g., microgreens, herbs, etc.) may be planted, for example, as these species can be seeded much more densely.

The cartridge may include additional holes 906 around its outer or inner edges that may not be intended for plant growth, and may allow for proper drainage, such a fluid drainage, to avoid microbial growth. In some embodiments, these holes 906 may be smaller than both the first holes 902 and the second holes 904. In some embodiments, these holes 906 may be larger than both the first holes 902 and the second holes 904. In some embodiments, these holes may be larger second holes 904 but smaller than the first holes 906. In some embodiments, the additional holes 906 may be provided in only a bottom cover of cartridge 900. Alternatively, the additional holes 906 may be provided in only a top cover or both a top and bottom cover of cartridge 900.

For example, the first holes 902 may range from at or about 16 to at or about 30 mm in diameter, the second holes 904 may range from at or about 12 to at or about 15 mm, and additional holes 906 may range from at or about 5 to at or about 11 mm diameter. The first and second holes may be separated from each other and from the edges of the cartridge by a distance of at or about 1 mm to at or about 30 mm, for example. The spacing and organization of the holes may provide for the most efficient use of the cartridge with optimal plant growth.

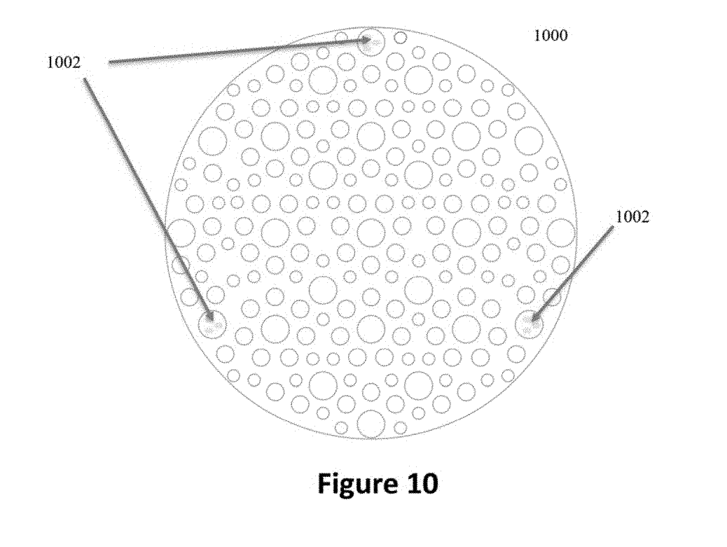

FIG. 10 shows an exemplary cartridge 1000 having a number of holes. As shown by FIG. 10, cartridge 1000 may include one or more seeds 1002 within one or more of the holes. For example, the holes where seeds 1002 are located in FIG. 10 may be first holes 902. The holes where seeds 1002 are located in FIG. 10 form a hole configuration in a triangular shape, such as triangular shape 912. Tiny Tim Tomatoes and other large, fruiting species may be seeded in one or more of the first holes 902 of cartridge 1000 in a hole configuration that forms a triangular shape 912.

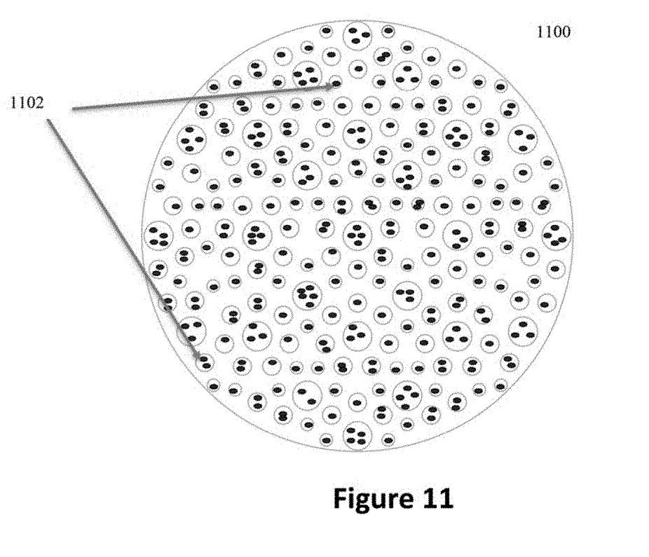

FIG. 11 shows an exemplary cartridge 1100 having seeds 1102 located in each of its holes. Cartridge 1100 may include a number of holes, including one or more of first hole 902, second hole 904, and additional hole 906 described with reference to FIG. 9. For example, genovese Basil and other smaller, herbaceous plants may be seeded across the cartridge, utilizing a plurality of holes including one or more of holes 902, 904, and/or 906. In some embodiments, the seeding may be performed substantially evenly across the cartridge. In some embodiments, the seeding may not be performed substantially evenly across the cartridge, and may instead be concentrated into one or more regions of the cartridge or one or more of holes 902, 904, and/or 906.

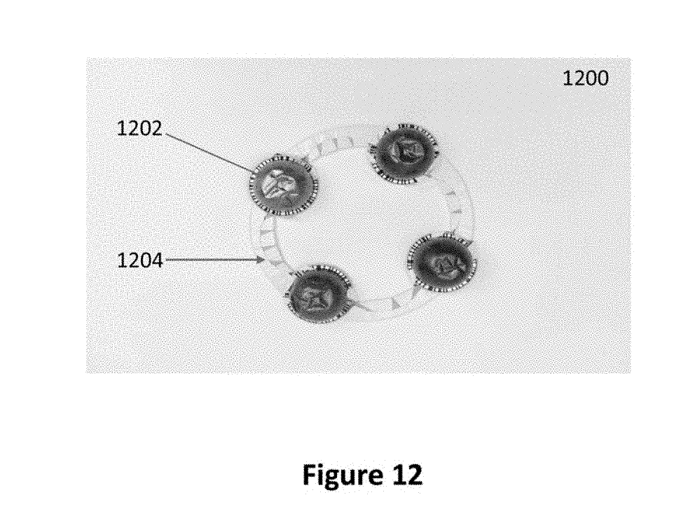

FIGS. 12-18 show exemplary implementations of a cartridge in accordance with embodiments of the present disclosure. For example, FIG. 12 shows an exemplary cartridge 1200 having a number of seed holders 1202 connected by a connector 1204.

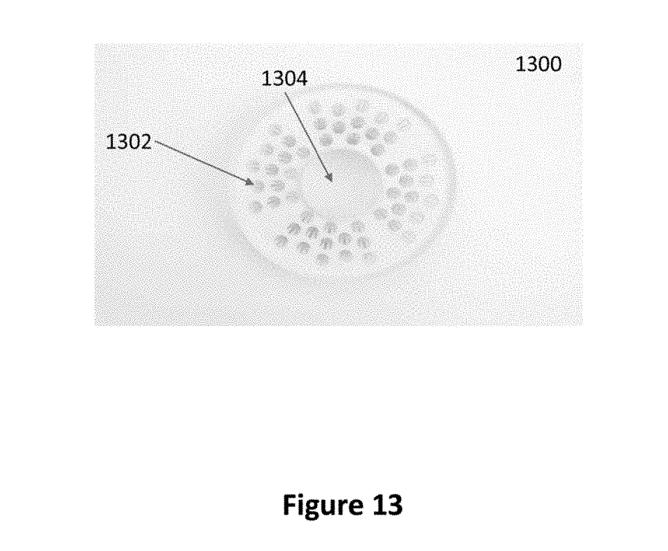

FIG. 13 shows an exemplary cartridge 1300 having a number of holes 1302. Once or more seeds may be placed in one or more of holes 1302. As shown by FIG. 13, holes 1302 may extend radially outward from a center region 1304 of cartridge 1300. In one example, there may be fewer holes 1302 that directly border center region 1304 than there are that do not border center region 1304. In one example, there may be fewer holes 1302 in a first row of holes that directly border center region 1304 compared to one or more other rows holes of cartridge 1300.

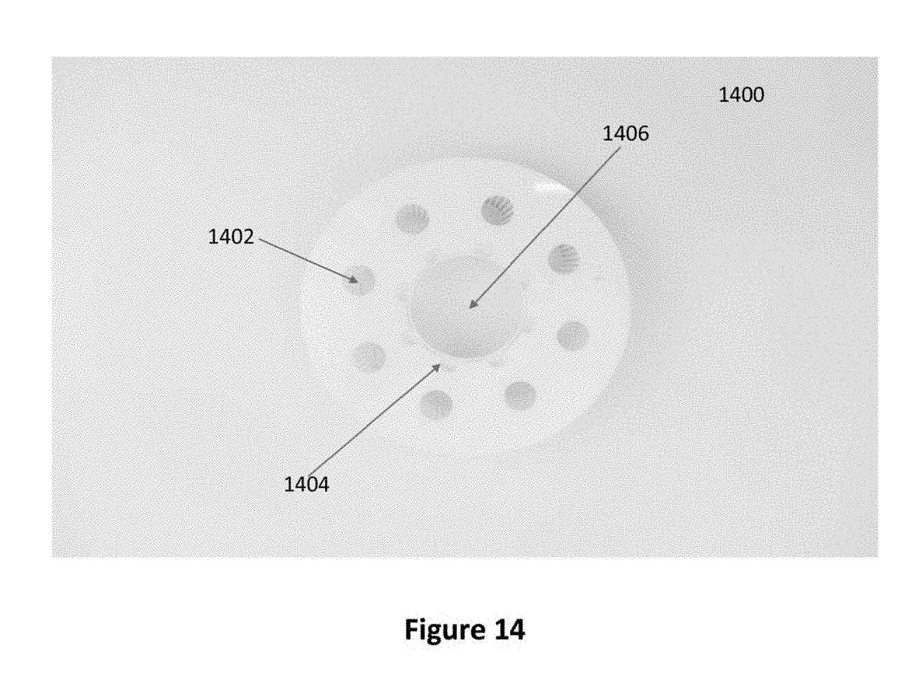

FIG. 14 shows an exemplary cartridge 1400 having a number of holes 1402 and 1404. Holes 1402 are situated in a row around center region 1406. Holes 1404 are also situated in a row around center region 1406. Holes 1404 are located closer to center region 1406 compared to holes 1402. Holes 1404 may be smaller, larger, the same, or substantially the same size compared to holes 1402.

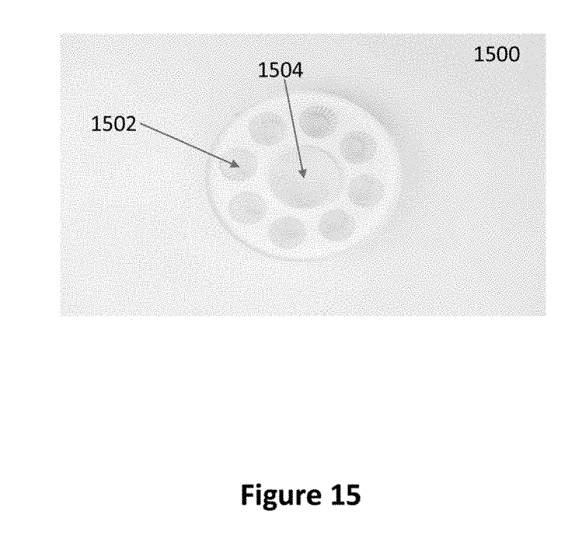

FIG. 15 shows an exemplary cartridge 1500 having a number of holes 1502 situated in a row around center region 1504. Cartridge 1500 may have a single or multiple rows of holes 1502. Holes 1502 may be the same or substantially the same size, or one or more of holes 1502 may be larger or smaller than one or more other holes, for example.

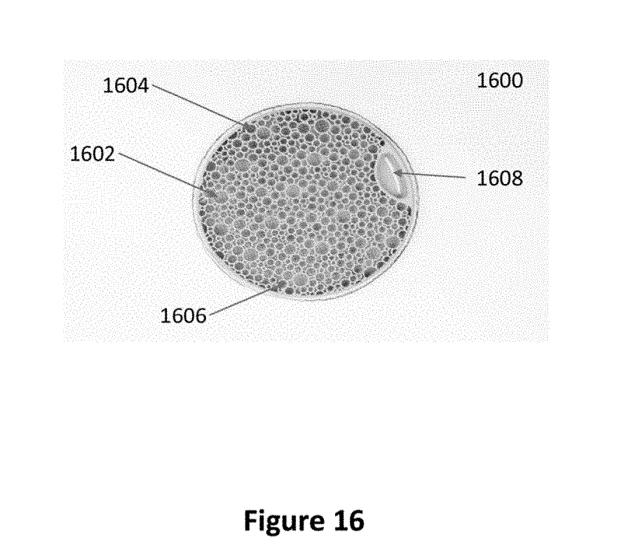

FIG. 16 shows an exemplary cartridge 1600 having a number of holes 1602, 1604, and 1606. Hole 1602 may be sized larger than hole 1604. Hole 1604 may be sized larger than hole 1606. Cartridge 1600 may include a handle 1608 that allows for holding of cartridge 1600 by a user.

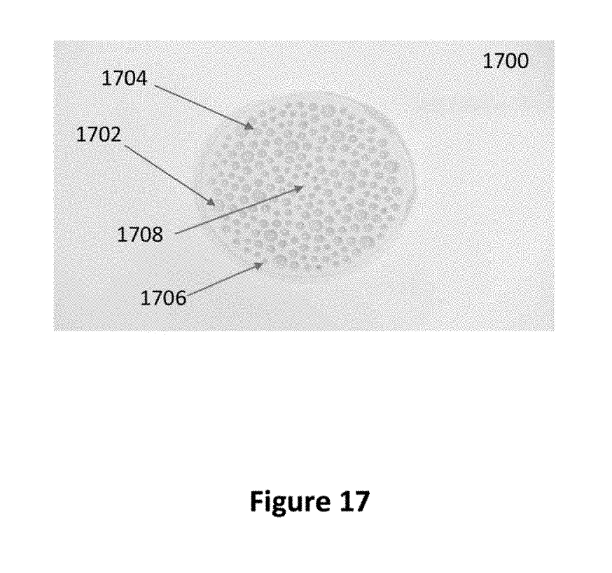

FIG. 17 exemplary cartridge 1700 having a number of holes 1702, 1704, and 1706. Hole 1702 may be sized larger than hole 1704. Hole 1704 may be sized larger than hole 1706. Cartridge 1700 may also include a center hole 1708, located at the center or substantially the center of cartridge 1700. Center hole 1708 may attach or affix cartridge 1700 to a smart, indoor micro-gardening system such as unit 100, for example.

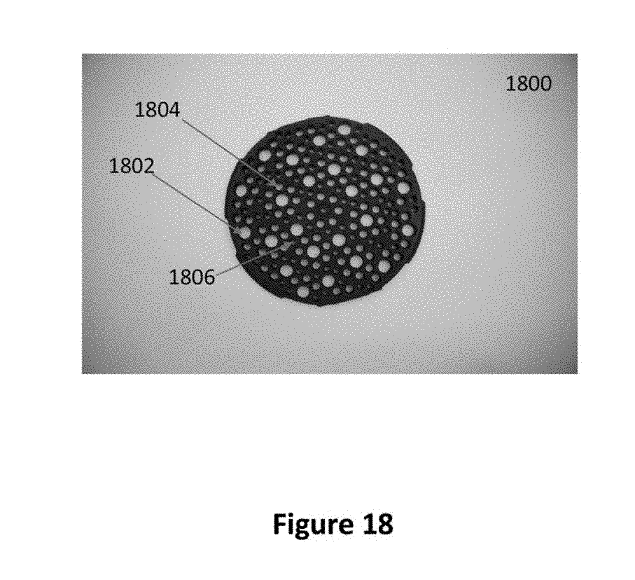

FIG. 18 shows an exemplary cartridge 1800 having a number of holes 1802, 1804, and 1806. Hole 1802 may be sized larger than hole 1804. Hole 1804 may be sized larger than hole 1806.

Regarding the size of cartridge holes discussed with respect to FIGS. 12-18 as well as other exemplary cartridges of the present disclosure, the term “size” and the like may refer to one or more of the size of the diameter, radius, circumference, and/or depth of holes. Moreover, holes may have a uniform circumference within the hole as the depth of the hole increases, or may have a circumference within the hole that changes as the depth of the hole increases. For example, as a hole depth increases, the circumference within the hole may get smaller. In another example, as the hole depth increases, the circumference within the hole may get smaller.

Moreover, it should be understood that the cartridge holes discussed with respect to FIGS. 12-18 and other exemplary cartridges of the present disclosure may have a variety of shapes. For example, one or more holes of a cartridge may be circular, oval, triangular, square, pentagonal, hexagonal, heptagonal, octagonal, or take any other shape. A cartridge may include uniformly shaped and/or sized holes, or may include one or more holes having different shapes and/or sizes.

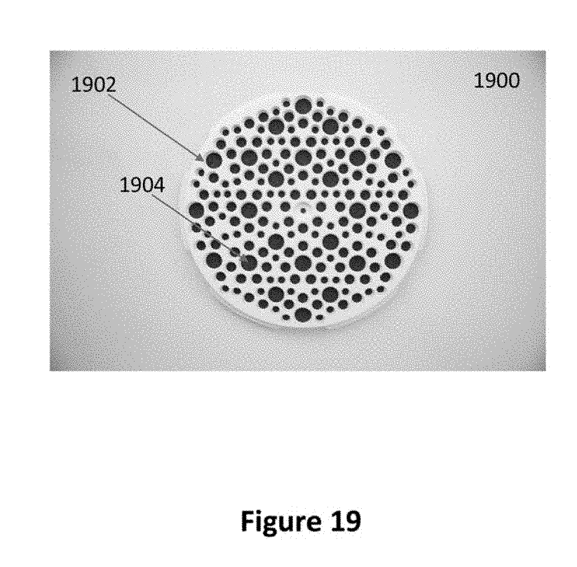

FIG. 19 shows an exemplary cartridge 1900 having a number of holes 1902. Within cartridge 1900 may be a substrate 1904. Substrate 1904 may be placed within cartridge 1900 and may be situated such that the holes 1902 provide an opening to substrate 1904. For example, at the bottom of each hole 1902 may be substrate 1904.

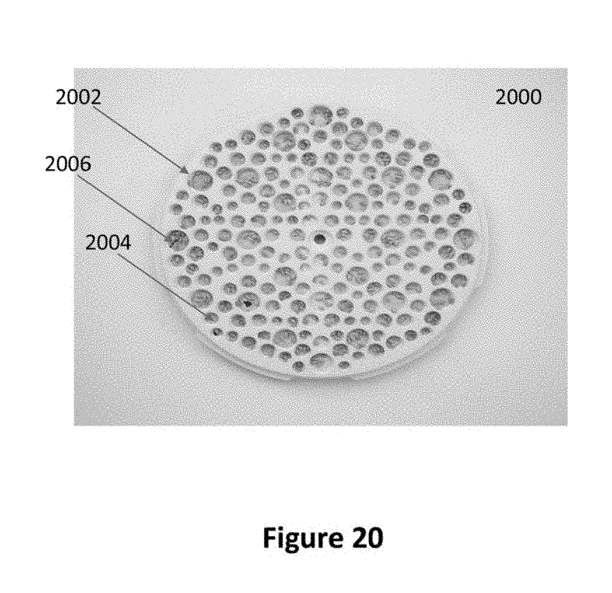

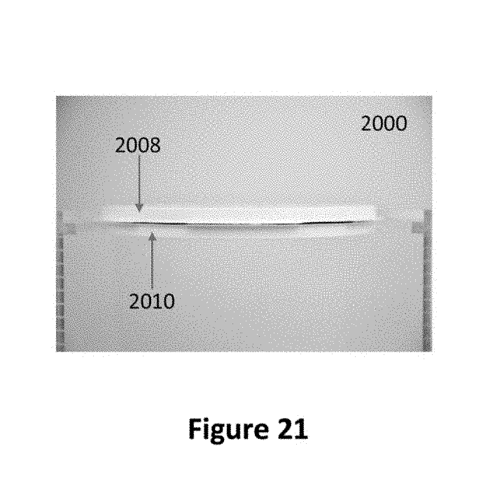

FIG. 20 shows an exemplary cartridge 2000 that includes a number of holes 2002, a substrate 2004, and seeds 2006 located within one or more of the holes 2002 resting on substrate 2004. Cartridge 2000 may include an adhesive on substrate 2004 that adheres seeds 2006 to substrate 2004. Substrate 2004 may include a nutrient growing media that includes one or more nutrients that may help in growth of seeds 2006. FIG. 21 shows a side view of exemplary cartridge 2000. As shown in FIG. 21, cartridge 2000 may be formed of a first component 2008 and a second component 2010. One or both of components 2008 and 2010 may include one or more holes 2002. Substrate 2004 may be situated between components 2008 and 2010. For example, substrate 2004 may be enclosed by components 2008 and 2010. For example, substrate 2004 may be sandwiched between components 2008 and 2010.

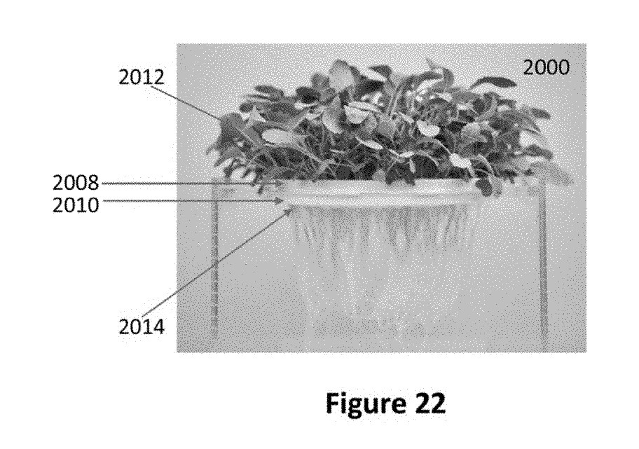

In one example, component 2008 may include holes 2002, while component 2010 includes other holes, which may be sized the same or substantially the same, smaller, or larger than holes 2002, and which may allow for root growth through them. FIG. 22 shows a side view of exemplary cartridge 2000 growing a plant having leaves 2012 and roots 2014. Leaves 2012 originate from holes 2002 in first component 2008, while roots 2014 originate from other holes in second component 2010. The plant may be a lacinato kale, for example.

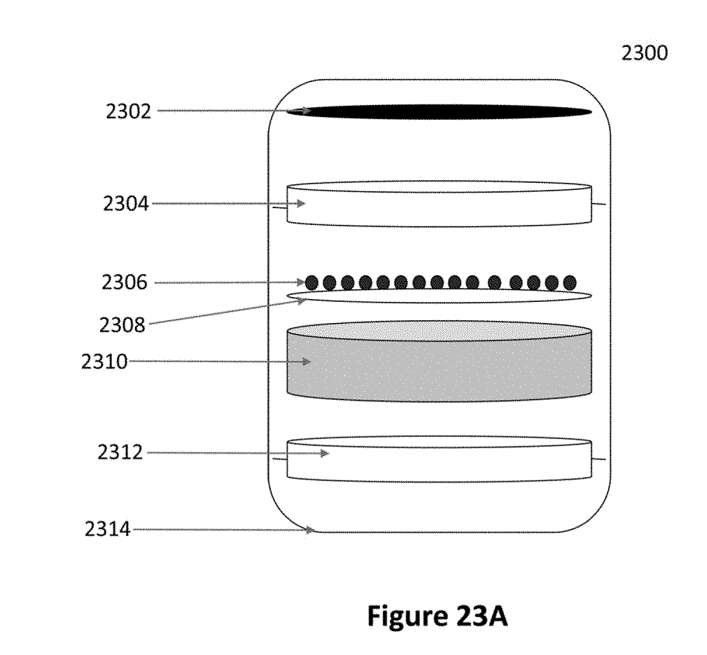

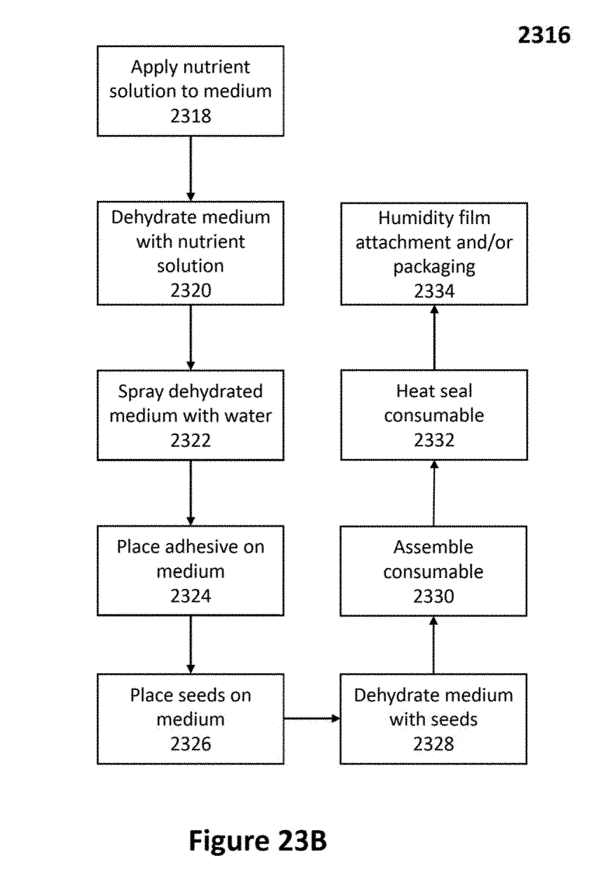

FIG. 23A shows exemplary components of an exemplary cartridge 2300 in accordance with some embodiments of the present disclosure. It should be noted that cartridge 2300 may include more of or less of the layers shown in FIG. 23A, and that FIG. 23A is exemplary only. It should also be noted that cartridge 2300 may be the same cartridge that is discussed in other parts of this disclosure. For example, cartridge 2300 may be cartridge 900 of FIG. 9. This is true of all cartridges discussed in this disclosure—namely, that discussion with respect to a cartridge of one figure may also be applicable to a cartridge discussed with respect to a different figure, and cartridges discussed in this disclosure may be the same cartridge. Moreover, cartridges of the present disclosure may be consumable seed cartridges.

The cartridge 2300 may include, for example, an external shell (including, for example, top and bottom external covers 2304 and 2312) and its compostable adhesive sealant, an internal growing media 2310, seeds 2306, seed adhesive 2308, nutrients (e.g., within media 2310), humidity film 2302, and packaging 2314. In one example, external covers 2304 and 2312 may be separate pieces of material that are attached to each other by an adhesive sealant. In another example, external covers 2304 and 2312 may be a single, unitary piece of material that allows for the insertion of internal components (e.g., internal growing media) via a side opening. The packaging 2314 may include Quick Response (“QR”) and/or Universal Product Code (“UPC”) code labels, for example. The shell (formed by covers 2304 and 2312, for example) may be composed of a durable, sturdy, and bio-based plastic-like material, for example including polylactic acid or a polyhydroxyalkanoates material, that may provide support for plant roots and shoots throughout the entire lifecycle. At the end of the plant's life, the cartridge 2300 can be composted or recycled, so that no waste is generated in the process. In some embodiments, the shell may have a pattern of sized and/or shaped holes punched through it, which may allow for the optimal growth of a variety of plant types and sizes. In some embodiments, the internal growing media 2310 may be one or more sheets of porous bio-based material, such as a material including polylactic acid. The nutrient solution of media 2310, which may be specific to plant type and infinitely customizable based on user preferences, may be dried onto the internal growing media 2310. For example, the nutrient solution may be dried onto the internal growing media 2310 using a dehydration application method that may allow for ease of shipment and may only need a user to add water to it to begin growing. The nutrient solution may contain any number of combinations of macro and micro nutrients in order to achieve and optimize a desired produce outcome. For example, a standard Genovese basil plant may receive a nutrient solution containing a ratio of 2% nitrogen, 2% phosphorous, 3% potassium, 2% calcium, and 0.75% magnesium. Fruiting species like tomato, for example, may require a higher percentage of phosphorous and may receive a nutrient solution containing the following ratio: 1% nitrogen, 5% phosphorous, 4% potassium, 1% calcium, and 0.5% magnesium.

One or more seeds 2306 may be placed on a top side of the internal growing media 2310, which may provide proper support for establishment and growth of the seed(s) 2306. Based on seed size, underneath or above the seeds may be a layer of water soluble material that may form adhesive 2308, which may be dried and may serve to adhere the seed(s) 2306 to the internal growing media 2310. This water soluble material forming adhesive 2308 may be comprised of a cellulose and starch based paper. The cartridge 2300 may include an external cover (for example, formed by top and bottom external covers 2304 and 2312) that may be placed over the seed(s) 2306 and adhesive 2308 and may be sealed at their edges to enclose the assembled seed disk. The humidity film 2302 may be then placed and attached on a top of the external cover such that it is located above the top external cover, and may stay in place during germination to maintain proper lighting and humidity conditions within the cartridge, for example, and then may be removed for plant growth, for example. Adhered to the humidity film 2302 may be one or more labels, for example. One or more of the labels may include a QR code. One or more of the labels may include a UPC code. For example, two labels may be attached to the humidity cover, where one label includes a QR code, and the other label includes a UPC code. The QR code may indicate plant specific information and a growth profile based on seed type and user requests, for example. The UPC code label may indicate information on that individual cartridge 2300, such as seed origin, date seeded, and/or storage instructions, for example.

As noted, for example, cartridge 2300 may include humidity film 2302. Humidity film 2302 may help regulate humidity in cartridge 2300 so that growth within cartridge 2300 is not damaged by humidity changes. In one example, humidity film 2302 may be opaque. For example, an opaque humidity film 2302 may be used when the species grown in cartridge 2300 is a dark-germinating species. In another example, humidity film 230 may be transparent. For example, a transparent humidity film 2302 may be used when the species grown in cartridge 2300 is a light-germinating species.

In some embodiments, the humidity film 2302 may temporarily maintain a moist environment within the cartridge in order to induce germination. As some plant types may require light to germinate but some may not, the humidity film 2302 may be either transparent or opaque. The humidity film 2302 may be made of a bio based plastic material, which can be removable. For example, the humidity file 2302 may be removed by the user and then returned to its original position. To maintain proper humidity while reducing material usage, the humidity film 2302 may range in thickness from at or about 0.10 mm to at or about 0.50 mm, for example. The humidity film 2302 may be designed to fit over the cartridge external covers and may have a diameter ranging from at or about 250.0 mm to at or about 270.0 mm, for example.

Cartridge 2300 may include external top 2304. External top 2304 may be located below humidity film 2302. In one example, external top 2304 may be first component 2008, discussed above. External top 2304 may include a number of holes, and may also provide protection for seeds situated within cartridge 2300.

Cartridge 2300 may include seeds 2306. Seeds 2306 may have a multitude of shapes, sizes, quantities, germination patterns, light exposure criteria, and density distributions which may be accommodated by the cartridge. Indeed, one or more different types of seeds 2306 may be located within cartridge 2300. Seeds 2306 may be attached to internal growing media 2310 via adhesive 2308. Adhesive 2308 may be a cartridge adhesive, for example. Internal growing media 2310 may provide a substrate for growing plants from seeds 2306, and may include one or more nutrients that assist in growing seeds 2306.

For example, in some embodiments, the internal growing media 2310 may house seeds and/or nutrients, and may provide the support needed for proper root and shoot development. The internal growing media 2310 may be comprised of one or more sheets of thin, porous, sturdy material. The pores within the material may allow for water uptake and storage (which may support germination and/or plant health), as well as air exchange between the basin and the environment. The material may be thick enough to ensure a secure fit within the cartridge external covers 2304 and 2312 so that it may remain in place, but loose enough so that water storage and air exchange are not inhibited. It may, at the same time, be dense and sturdy enough to support root establishment and plant growth. The material may be also designed to be the proper thickness to ensure the correct degree of separation between the nutrients and the seeds to prevent possible damage due to contact. To ensure this proper distance is achieved, the internal growing media 2310 may range in thickness from at or about 4.0 mm to at or about 7.0 mm. The internal growing media 2310 may be designed to fit within the cartridge external covers 2304 and 2312 and therefore may range in diameter from at or about 215.0 mm to at or about 250.0 mm. The internal growing media 2310 can be colored with natural dyes.

In some embodiments, adhesive 2308 may hold seeds 2306 in place during shipment, and then may essentially disappear once the cartridge is placed in the basin and watered, so as not to interfere with germination and overall plant growth and health. Therefore, the seed adhesive 2308 may be a thin bio-based, water soluble material. The material may not contain any sugars or starches. In some embodiments, the material may be wet and then placed on top of the internal growing media 2310 underneath the seeds, or on top of the seeds (depending on plant type), allowing it to mold to the internal growing media 2310 and seeds 2306 and hold everything in place, without inhibiting seed germination. Once the cartridge is watered through, the material may dissolve and fall into solution within the basin. Any material that is left on the internal growing media 2310 may be thin enough so as not to interfere with germination. To help ensure the adhesive 2308 does not interfere with seed germination or plant growth, thickness of the adhesive material may range from at or about 0.02 mm to at or about 0.10 mm, for example. The diameter of the adhesive material may be designed so that the entirety of the internal growing media 2310 surface is covered; therefore this diameter could range from at or about 215.0 mm to at or about 250.0 mm, for example.

In some embodiments, the nutrients of internal growing media 2310 may vary based on plant type and the outcome desired by the user. Different nutrient formulations may be made using different ratios of macronutrients and micronutrients to achieve the desired outcome of the plant. The cartridge may come with additional nutrients depending on plant type, and these nutrients may be supplied in packets within the cartridge for a time release based application over the life cycle of the plant. The packets may be sealed packets.

Cartridge 2300 may include external bottom 2312. External bottom 2312 may be located below growing media 2310. In one example, external bottom 2312 may be second component 2010, discussed above. External bottom 2312 may include a number of holes, and may also provide protection for seeds situated within cartridge 2300. External cartridge 2300 may further include packaging 2314, which may encompass or otherwise surround all or some of elements 2302, 2304, 2306, 2308, 2310, and 2312.

In some embodiments, packaging 2314 may comprise a layer of sealed bio-based plastic material. This packaging 2314 may keep out moisture and/or pollutants to ensure a long shelf life of the cartridge. The packaging 2314 may be durable and sturdy enough to maintain its form and protect the internal materials during shipping and handling, so that the entire cartridge arrives intact at any destination. The packaging may include compostable labels, such as one or more of the QR and/or UPC code labels (e.g., a unique identifier code label), for example.

As discussed, cartridge 2300 may include external top 2304 and external bottom 2312. One or both of these covers may provide support and space for the roots and shoots of a variety of plant types and sizes. This may be achieved through the unique pattern of hole sizing and/or spacing, which may allow for optimal growth of wide range of plants, all within the same, or similar external structure. For example, proper support for plants may be provided through the rigid material of which the top and/or bottom covers 2304 and 2312 may be composed, which may range in thickness from at or about 0.10 millimeters (mm) to at or about 0.40 mm, for example. This range of thickness may allow for the optimal amount of support while reducing material use and cost. Both the cartridge top and bottom covers 2304 and 2312 may have a diameter ranging from at or about 228 mm to at or about 381 mm, for example, which may allow for proper plant growth. The top and/or bottom covers 2304 and 2312 may include one or more tabs along their edges for proper fit within a micro-gardening system basin.

The cartridge's top and/or bottom 2304 and 2312 may be made of a bio-based plastic material which may have a certain durability and/or ability to maintain its form and support throughout a plant's life cycle. For example, the material may provide protection for the internal contents of the cartridge during shipment. The plastic may be composed of such a material that the cartridge may be composted in its entirety to reduce waste generation. The cartridge may be sealed with either compostable glue or heat sealing or both, for example.

In some embodiments, the cartridge top and bottom external covers 2304 and 2312 can be expanded to accommodate the growth of larger plant varieties, such as root vegetables, which may require more space to fully develop.

The bio-based plastic material may be thin, and therefore a decreased amount may be used per cartridge, which may reduce production costs. The cartridge may still remain rigid enough to provide support and structure to plants throughout their lifecycle. The manufacturing process for the cartridge, and this material may be based on the design of a clamshell packaging, which may allow for straightforward and effective manufacturing. The holes discussed herein may accommodate a wide variety of plant species (see e.g., FIG. 9).

In some embodiments, the cartridge of the present disclosure may act as a physical and virtual data packet. For example, while the cartridge form factor may remain the same and is able to accommodate multiple plant types and growth patterns, the contents/components within it can be infinitely customized. The way that the produce is grown can also be infinitely customized by altering a variety of growth settings of a micro gardening system (e.g., unit 100) based on the desired produce outcome. The information on how the cartridge has been physically customized, as well as the customized growing instructions for the unit, may be accessed by a unique identifier code (for example, the QR and/or UPC codes discussed previously) associated with each plant instance and stored within the cartridge. The cartridge may provide an all-in-one and completely compostable method to growing customized produce any time and any place.

The data stored within the unique identifier code may include information on the material origins of the cartridge so that every piece of the cartridge's manufacturing process and components are traceable, to ensure full transparency of the product. For example, information may include composition and origin of each piece of the cartridge, amount and origin of the specific seeds included, makeup of the nutrient solution, and location of assembly, and date of assembly. Second, the code may include either a standard or a customized growing profile, which may ensure the optimized growth of the plant based on specific user requests. This may include, for example, information on the optimum or desired growing environment, and/or one or more of the following criteria: lighting profiles, irrigation settings, seeding practices, nutrient additions, and watering requirements.

When the user receives their cartridge (for example, via the mail), they may place it into a micro-gardening system (e.g., unit 100) basin, and a camera located within a lamp head of the system may scan the code. The system then may download a growing profile and enable required settings, and may begin the growing cycle. The settings can be altered at any time by the user, through an application that may be present on a user's computing device, such as a cellular phone, personal computer, tablet computer, or the like, if changes are desired. This code also sends traceable information regarding the micro-gardening system to the user via the application interface so that the user may access all information related to what they are growing and consuming.

The cartridge may also allow for increased efficiency of a subscription refill service. For example, a camera of the micro-gardening system may have the ability to recognize when a plant growing in the cartridge has reached the end of its life cycle based on size, coloration, or overall appearance, for example. Alternatively, a user may decide to harvest the plant at any point, and alert the system by indicating harvest within the app. Once either situation is recognized, a notification may be sent to a database (e.g., the database previously discussed), which may allow for the next cartridge in a user's subscription to be prepared and sent to the user. This feature may allow for users to be continuously growing using the micro-gardening system.

FIG. 23B shows an assembly process 2316 for a cartridge in accordance with some embodiments of the present disclosure. For example, in step 2318, a precut, sized, and colored cartridge growing medium (e.g., substrate) may be placed on a work surface and the appropriate amount and type of nutrient may be applied to particular locations on the substrate using a pipetting system or robotic arm that can customize quantity, type, and location of the nutrient solution. The amount of nutrient solution may be dependent on plant type that will be grown in the medium; for example, fruiting species with high nutrient requirements may receive 20 mL/gallon of water, while a green like arugula may receive 10 mL/gallon. The nutrient solution may be applied in an even layer across the bottom of the internal growing media. At step 2320, the medium with nutrient solution may be placed into a dehydrator to seal the nutrients into the medium. Dehydration may provide the most compact and efficient method for containing nutrients within the cartridge, and the process may also reduce moisture, ensuring ease of transit as well as storage stability.

The medium with dried nutrients may be placed onto the work surface again and sprayed with water at step 2322. At step 2324, a precut and sized adhesive material may be then placed on top of the medium. At step 2326, an automatic vacuum seeder attached to a CNC robotic arm may then place the appropriate seed type in predetermined locations on the adhesive, designed to optimize growth. The medium with seeds and adhesive material may be then dehydrated at step 2328. For example, the medium with seeds may be placed into the dehydrator. Once entirely or substantially dried, the cartridge may be assembled and placed into a custom fixture where the edges of the cartridge may be sealed with a compostable glue, for example, at step 2330. Eventually, the cartridge may be heat sealed to reduce material waste at step 2332.

The robot system may have the ability to scan a barcode or a unique identifier (discussed above) associated with each cartridge it is assembling, and may determine the proper nutrient combination/placement, as well as the proper seeding locations and density as described above.

Following sealing of the cartridge, the humidity film, which may contain the unique identifier, such as a QR code and associated data, may be adhered to the top of the cartridge and the whole cartridge may then be placed into a machine in which the cartridge is wrapped and sealed in the bio based plastic packaging material, at step 2334. The cartridge may then be stored for an extended period of time, for example.

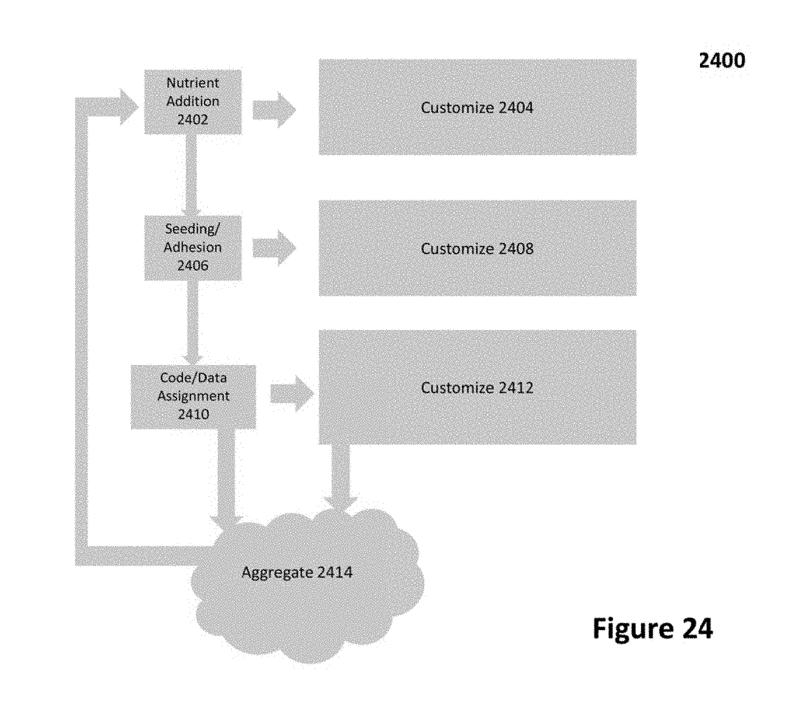

FIG. 24 shows an exemplary diagram of the assembly process 2400 for an exemplary cartridge. For example, infinite cartridge customization may be possible both physically in the assembly process and through systematic changes in the growth settings through data stored within the cartridge. All cartridges can be the same general format, but each can be assigned a traceable QR code which attaches unique data to inform the micro-gardening system and computerized application how that plant will be grown and unique attributes through the physical assembly, such as nutrients and seeding.

For example, process 2400 may include nutrient addition 2402, which may include the addition of one or more nutrients to an internal growing medium of a cartridge. The nutrient addition 2402 may be customized, as indicated by box 2404 in FIG. 24. For example, customizing may include varying nutrient placement during the assembly process based on plant type, desired plant size, and/or the level of maturity the plant will reach. The type of nutrients and number of nutrients added to the internal growing medium may also be varied based on the plant type, desired size, and/or level of maturity.

For example, process 2400 may include seeding/adhesion 2406, where seeds may be adhered to internal growing medium. This step may be customized as indicated by box 2408 in FIG. 24. For example, customizing may include varying the seed type, seed location within the cartridge, and/or seeding density, for example. These aspects can be altered based on the desired product outcome.

For example, process 2400 may include code/data assignment 2410, where a unique identifier, such as a QR and/or UPC code may be assigned to a cartridge. The settings associated with the unique identifier may be customized as indicated by box 2412 in FIG. 24. For example, customizing may include assigning a growth profile (which can be changed by the user, if desired) to the identifier that can indicate that particular settings of plant growth associated with the cartridge are automated, and which can optimize growth based on the user's desired outcome. The variables include, for example, the amount and/or strength of various LED lighting channels, misting settings, and number of nutrient additions.

For example, process 2400 may include aggregation 2414. Here, for example, data from each growth instance in each cartridge may be aggregated in one or more databases and used to inform future applications. The future applications may be, for example, both general and user specific, allowing for further customization of the process. For example, the future applications that may be customized may include future cartridge assembly.

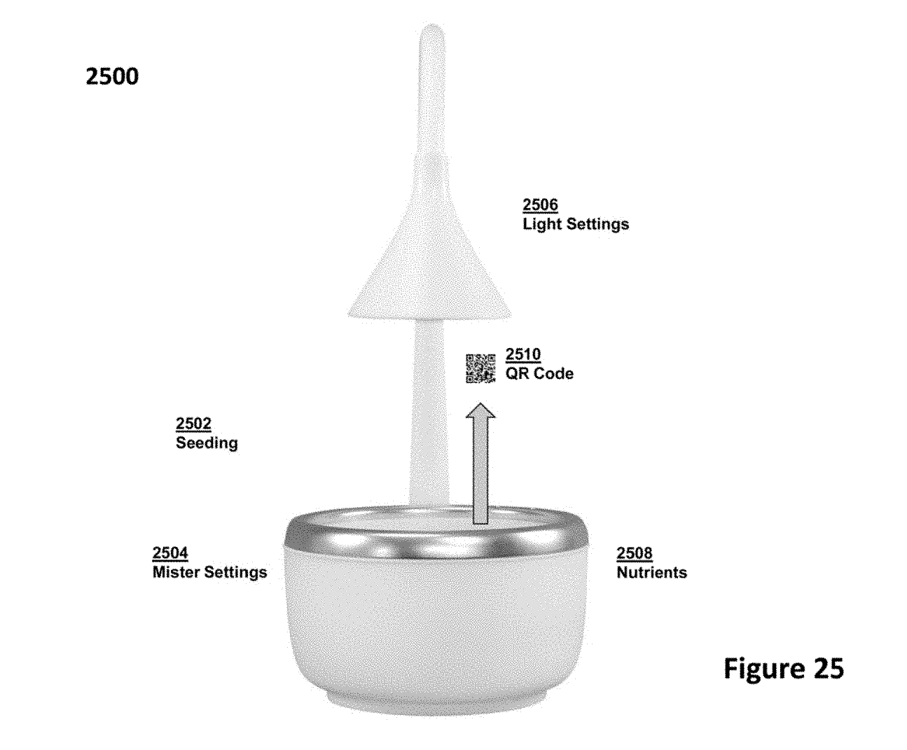

FIGS. 25A-25C show an exemplary growing unit 2500 using an exemplary cartridge. Unit 2500 may be the same as unit 100, for example. FIG. 25A shows various settings 2502, 2504, 2506, 2508 for growing a plant in unit 2500. The plant may be seeded within a cartridge of unit 2500, and the cartridge may include a QR code 2510. QR code 2510 may be read by unit 2500, and may cause unit 2500 to acquire one or more of settings 2502, 2504, 2506, 2508 from one or more databases such that unit 2500 can be adjusted using one or more of 2502, 2504, 2506, 2508 to effectuate controlled growing of the plant. For example, the settings may refer to how a standard Tiny Tim tomato should be grown by unit 2500. In another example, the settings may refer to how a Genovese basil should be grown by unit 2500. In another example, the settings may refer to how multiple different plants should be grown simultaneously within unit 2500. The QR code 2510 may reflect that one or more of the growth settings 2502, 2504, 2506, and 2508 should be obtained by one or more databases, and also may reflect seed origin and seeding date within the cartridge.

Setting 2502 reflects, for example, seeding for the cartridge in unit 2500. Setting 2502 may reflect the density of seeding within the cartridge, which may be, for example, 3 seeds in each of three larger sized holes (e.g., the first hole described above). Setting 2502 may also reflect the amount of seeds within a cartridge. The amount may be the number of seeds, or may be the weight of seeds within the cartridge. Setting 2502 may reflect the location of seeds within the cartridge. For example, the location may be reflected as a pattern, such as a triangular, square, pentagonal, hexagonal, heptagonal, or octagonal pattern, for example. Other patters, such as checker board and zig-zag, for example, may be used. The locations of seeds may correspond to one or more holes of an external top and/or bottom (e.g., 2304, 2312) of a cartridge.

Setting 2504 reflects, for example, mister settings for unit 2500 to grow a plant of the cartridge. The mister settings may include, for example, duration and/or frequency of misting. The duration may be, for example, 15 seconds. The frequency may be, for example, every 15 minutes. The duration and frequency may be any number of different values. Moreover, the frequency may be set to occur within certain time windows. For example, in a first time window, the frequency may be every 10 minutes, but in a second time window, the frequency may be every 30 minutes.

Setting 2506 reflects, for example, light settings for unit 2500 to grow a plant of the cartridge. For example, the light settings may adjust one or more of the channel intensity, duration, and frequency of light applied to seeds of a cartridge by unit 2500. For example, the settings may indicate one or more of red, far red, blue, and/or white channels for light, and may indicate percentage intensity for each of these channels. For example, the red channel may be set to 30 percent intensity, the far red channel may be set to 5 percent intensity, the blue channel may be set to 30 percent intensity, and the while channel may be set to 30 percent intensity. The duration may be set to 18 hours, for example. The frequency may be set to daily, for example. The duration may be on the order of a predetermined number of minutes, hours, or days, for example. The frequency may be on the order of a predetermined number of minutes, hours, or days, for example.

Setting 2508 reflects, for example, nutrient settings for unit 2500 to grow a plant of the cartridge. For example, the settings can indicate the formulation of nutrients (e.g., which nutrients are present and the concentration of each nutrient), and the amount and location of nutrients present in the cartridge. For example setting 2508 may indicate a certain formulation of nutrients A, B, and C, that the amount is 2 tsp. per gallon of water added to the growth medium, and that the nutrients were concentrated in the center of the cartridge growing medium. Additions to the nutrients may also be indicated by the settings 2508.

It should be noted that plants may be customized based on requests from a user, who may adjust unit 2500 settings via control of an application on a computing device or via unit 2500 itself. Indeed, one or more of the growth settings 2502, 2504, 2506, and 2508 may be adjusted by a user and customized to the user's preferences. For example, three are numerous possible combinations of different nutrient solutions, and a different combination can be used for each cultivar or for each plant instance.

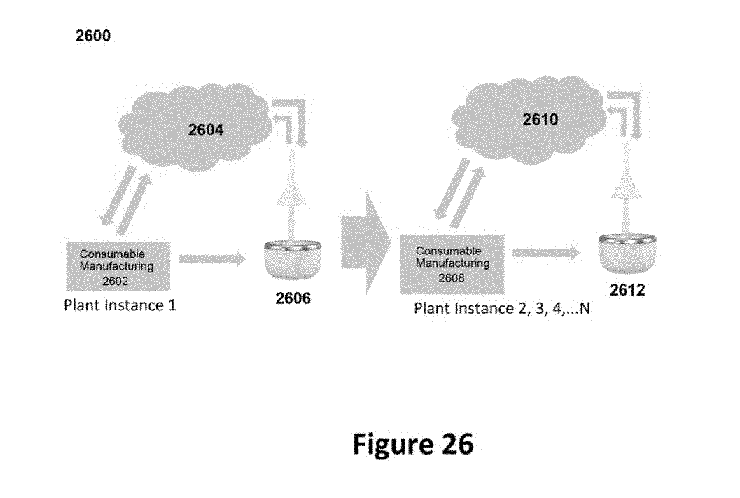

FIG. 26 shows an exemplary process 2600 for producing cartridges in accordance with the present disclosure. For example, process 2600 may include cartridge manufacturing at step 2602. Here, for example, a cartridge may be manufactured having settings 2604 received from one or more databases. Settings 2604 may be settings as previously discussed, and may direct how a growing unit should operate. The settings may be a standard setting for a particular seed type/plant of the cartridge, or may include customized settings that deviate from the standard setting. For example, the customized settings may be received at the databases from one or more plant growing units 2606, and may reflect settings that were previously used for growing the same plant within a unit 2606. The manufactured cartridge may then be used by a unit 2606. In another plant instance (e.g., instances 2, 3, 4, to N), a cartridge may again be manufactured at step 2608. Settings 2610 may be received from one or more databases, and may be further customized compared to settings 2604 because they include further information of cartridge growth settings from one or more units 2612. Indeed, the cartridge manufacturing at step 2608 can be influenced and refined, for example, by prior growth settings, cartridge settings, and growth profiles from previously manufactured cartridges for the same or different seed types. The manufactured cartridge of step 2608 may then be used by a unit 2612.

Indeed, with respect to FIG. 26, the creation of each of the plant instances can be informed and initiated by requests from users. Information from those initial requests, from data collected during the first plant instance in each unit, and from requests prior to a user's second (and third, fourth, and so on . . . ) plant instance can be used to inform the production of the next cartridge and growth profile that user will receive. Data can be used to form a progressive loop in which information from each individual cartridge and plant instance can be stored within the larger platform and transferred forward to be used to inform future cartridge production. This may allow for the improved performance of future cartridges both generally and based on individual users' desired outcomes.

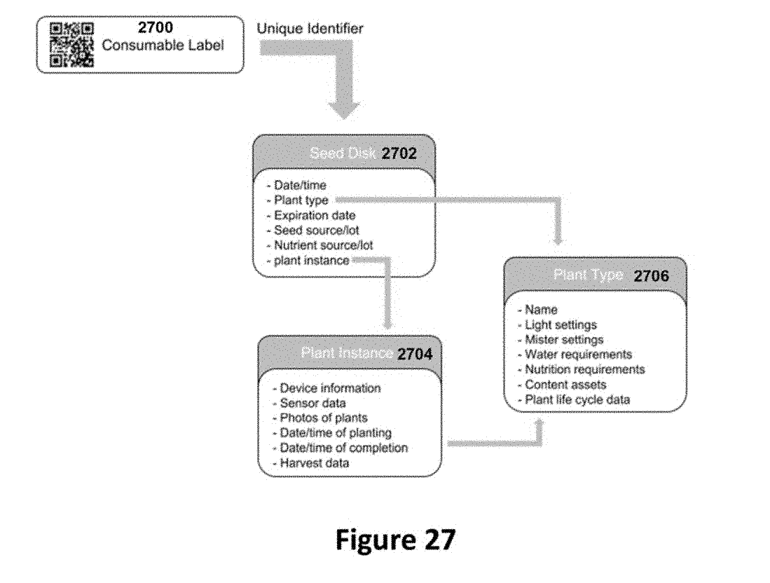

FIG. 27 shows an exemplary cartridge label 2700 that may include a unique identifier, such as a QR code or UPC code, as discussed above. Label 2700 may be adhered to a seed cartridge, packaging of the seed cartridge, or any other layer of the cartridge. In another example, label 2700 may be branded or otherwise printed or formed directly on a seed cartridge, packaging of the seed cartridge, or any other layer of the cartridge. For example, the unique identifier described may also allow the micro-gardening system to collect and store data regarding the health and overall growth of that specific plant within that unique and specific environment for that plant instance. There may be system and user verification for each plant instance, and data may be aggregated in one or more databases, such as cloud databases, from all past and current plant instances.

In some embodiments, the system may be automated to collect data on each specific cartridge, such as data regarding one or more of its installation date within a unit (e.g., unit 100) and geographic location, ambient lighting, electrical conductivity and pH of the nutrient solution, water level, and overall plant health. This data may be collected through a variety of sensors located in the unit's basin, as well as sensors and a camera system that may be located in a lamphead of the unit.

In some embodiments, users may be able to supply feedback and information on produce/system status by answering a variety of questions through a computer application interface, throughout the growth of each cartridge. Such questions may ask for information on one or more of germination rate and/or timing, produce coloration and/or flavor, and the timing of flowering and fruiting phases.

In some embodiments, the data on each specific cartridge and/or feedback and information on produce/system status may be collected from every cartridge grown, and may be stored in a database (e.g., a database as previously discussed). In some embodiments, the combination of the data on each specific cartridge and feedback and information on produce/system status may be used to create a third data set (see FIG. 27). This aggregated data may be used by artificial intelligence (AI) (e.g., AI algorithms and analysis) to inform future plant instances for each plant type. This may allow the system to learn from each plant instance in order to improve performance both on a general and an individualized scale, further customizing the experience for users.

Indeed, FIG. 27 shows, for example, data storage effectuated by each cartridge's label 2700. For example, label 2700 may include a unique identifier that reflects a variety of information pertaining to that particular cartridge. The information may include one or more of seed disk information 2702, plant instance information 2704, and/or plant type information 2706 for a particular cartridge. The information may be stored and/or tracked within this unique identifying code.

Seed disk information 2702 may include, for example, the date and/or time that the cartridge was made, the plant type that the cartridge is configured to grow, the expiration date for the cartridge, the seed and/or nutrient source and/or lot, and the plant instance. The seed and/or nutrient source and/or lot may refer to the specific purveyor and batch number associated with the seed and/or nutrients in that particular cartridge. Seed disk information 2702 may also store information on the particular materials used to assemble that cartridge, for example,

Plant instance information 2704 may provide further information of the plant instance information of seed disk information 2702. For example, plant instance information 2704 may refer to data the system may collect throughout the cartridge plant's life cycle. This data, associated with that one cartridge, may be stored, tracked, and used to inform future plant instances. For example, plant instance information 2704 may include device information regarding the device (e.g., unit 100) holding the cartridge and/or settings for a gardening system in which the seed cartridge is configured for installation, sensor data of the device, photos of plants captured by the device (e.g., unit 100), date and/or time of planting of the cartridge in the device, date and/or time of completion of growing for the cartridges plant(s), and information on harvesting, such as harvesting yield and time of harvesting, for example.

Plant type information 2706 may provide further information of the plant type information of seed disk information 2702. For example, plant type information 2706 may be stored and tracked within the unique identifier for each cartridge. This data may include the actual growth settings (e.g., lighting, misting, etc.) that may have been used to grow a plant in that particular plant instance. For example, plant type information 2706 may include one or more of the name of the plant (e.g., breed, identifying name, etc.), light settings of the device (e.g., unit 100) growing the plant, mister settings of the device (e.g., unit 100) growing the plant, water and nutrition requirements of the plant, content assets relating to the cartridge and/or plant, plant life cycle data, and settings for a gardening system in which the seed cartridge is configured for installation. The indicated information 2702, 2704, and/or 2706 of FIG. 20 may be formatted and stored within a database, such as a cloud database, and may contribute to a larger data set that could inform future growing.

As previously noted, in some embodiments, a computer application may be used to interact with systems of the present disclosure. In some embodiments, the application interface and associated code can be customized to achieve a particular outcome based on user preferences. For example, the application interface may allow the user to select produce by flavor profiles such as sweet or salty, which would result in the assembly and processing of a cartridge order to be different within each plant type. In some embodiments, the cartridge assembly process may allow for physical customization of the cartridge itself. Different produce outcomes, such as changes in produce size and quantity can be achieved through these physical processes. Various aspects of the cartridge may be altered during the assembly process to achieve a desired outcome. For example, the placement and composition of nutrients used may be customized to accommodate various outcomes such as plant size and level of maturity reached. In another example, the pattern and density of seeding may be varied in order to create produce of different sizes, morphologies, and locations on the cartridge.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., tiles that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A seed cartridge comprising:
a top external cover having a plurality of holes arranged in a shape, the plurality of holes including a first hole, a second hole, and a third hole, wherein the first hole is located on a contour of the shape;
a bottom external cover attached to the top external cover; and
a growing medium located between the top external cover and the bottom external cover, wherein the growing medium includes at least one nutrient.

2. The seed cartridge of claim 1, wherein the first hole is larger than the second hole.

3. The seed cartridge of claim 2, wherein a diameter of the first hole is larger than a diameter of the second hole.

4. The seed cartridge of claim 1, wherein the shape is a triangle or a square.

5. The seed cartridge of claim 4, wherein the first hole forms a first corner of the shape.

6. The seed cartridge of claim 5, wherein a fourth hole having the same or substantially the same size as the first hole forms a second corner of the shape.

7. The seed cartridge of claim 1, wherein the shape is a circle.

8. The seed cartridge of claim 1, wherein the bottom external cover comprises at least one hole.

9. The seed cartridge of claim 1, wherein at least one seed is attached to the growing medium by an adhesive.

10. The seed cartridge of claim 1, wherein the third hole is located at an edge of the seed cartridge.

11. The seed cartridge of claim 10, wherein the third hole is configured to provide drainage of fluid from the seed cartridge.

12. The seed cartridge of claim 1, wherein the seed cartridge is compostable.

13. The seed cartridge of claim 1, wherein a humidity film is located above the top external cover.

14. The seed cartridge of claim 13, wherein the humidity film is transparent.

15. The seed cartridge of claim 13, wherein the humidity film is opaque.

16. The seed cartridge of claim 13, wherein the humidity film is removable.

17. The seed cartridge of claim 13, further comprising packaging that encompasses the humidity film, top external cover, bottom external cover, and growing medium.

18. The seed cartridge of claim 17, wherein the packaging includes a unique identifier that is one of a quick response (QR) or universal product code (UPC).

19. The seed cartridge of claim 18, wherein the unique identifier indicates data reflective of a date that the seed cartridge was made and a plant type that the seed cartridge is configured to grow.

20. The seed cartridge of claim 18, wherein the unique identifier indicates data reflective of settings for a gardening system in which the seed cartridge is configured for installation.
